(19) United States
(12) Patent Application Publication
(10) Pub. No.: US 2014/0214753 A1
(43) Pub. Date: Jul. 31, 2014

(54) SYSTEMS AND METHODS FOR MULTI-SOURCE DATA-WAREHOUSING

(71) Applicant: Joseph Guerra, Cheshire, CT (US)

(72) Inventor: Joseph Guerra, Cheshire, CT (US)

(21) Appl. No.: 14/142,424

(22) Filed: Dec. 27, 2013

Related U.S. Application Data
(63) Continuation-in-part of application No. 13/842,232, filed on Mar. 15, 2013.
(60) Provisional application No. 61/746,951, filed on Dec. 28, 2012.

(51) Int. Cl. G06F 17/30

(52) U.S. Cl. CPC G06F 17/30563
USPC 707/602

(57) ABSTRACT

Preferred embodiments of the invention provide systems and methods for improving the speed and efficiency of a data warehouse. The invention enables the loading of data from different data sources into a common data warehouse structure. Preferred embodiments include an ETL process is modified to perform a joined indexing operation which reduces the number of lookup requests required. Further embodiments contemplate a date dimension and hierarchical data structure which improve operation speed.

### CROSS REFERENCE TO RELATED APPLICATION

This application is a continuation-in-part of U.S. application Ser. No. 13/842,232 filed on Mar. 15, 2013, which claims priority to U.S. Provisional Application No. 61/746,951 filed on Dec. 28, 2012, the entire contents of these applications being incorporated herein by reference.

### BACKGROUND OF THE INVENTION

Data warehouses provide systems for storing and organizing data that organizations use to plan and conduct business operations, for example. Data is organized using extraction, transform and load (ETL) operations to enable use of computer systems to access data for specific organizational needs. However, as the amount and complexity of data increases, existing tools are inadequate to provide access to the types of data that businesses need to conduct operations at the pace that is now required. Unfortunately, existing data warehouses are not a panacea for all business needs. Particularly, many warehouses are inefficient in their implementation and perform conventional operations in a manner which may render the system impractical for dealing with large datasets in a timely manner. There exists a need for novel systems and methods to improve data warehousing operations and to better coordinate data organization for analysis, input, and retrieval.

### SUMMARY OF THE INVENTION

Data warehouses typically maintain a copy of information from source transaction systems. This architecture provides the opportunity to perform a variety of functions. For example, the warehouse may be used to maintain data history, even if the source transaction systems do not maintain a history. The warehouse can also integrate data from multiple source systems, enabling a central view across the enterprise. This is particularly valuable when the organization has grown by one or more mergers, for example. A warehouse can also restructure the data to deliver excellent query performance, even for complex analytic queries, without impacting the transactional database systems. A warehouse may also present the organization's information in a consistent manner and restructure the data so that it makes sense to the business users. A warehouse may provide a single common data model for all data of interest regardless of the data's source.

Different data sources typically have different characteristics requiring different processes to perform data formatting and transfer into different data warehouses. Many organizations or entities (e.g. businesses, governmental organizations, non-profit entities) utilize two or more data sources to generate reports or facilitate decision making. However, such entities typically experience difficulties in accessing and analyzing data from these different sources. Preferred embodiments of the invention utilize different data transfer processes, often referred to as ETL operations, to enable the organization to manage the movement of data from a plurality of sources into a data warehouse. The ETL system is configured to provide for the loading of data from a plurality of sources having different characteristics into a data storage system. The ETL system can utilize a plurality of stages in order to organize data into the required format to achieve reporting of information from a single storage platform so that data from different sources can be retrieved and reported in a single reporting sequence. In a preferred embodiment, a plurality of ETL processes serve to load data from a corresponding plurality of sources into a corresponding plurality of intermediate storage devices referred to herein as repositories. A second plurality of ETL processes can then extract data from the repositories, and transform and load the data into a single data warehouse. The second stage ETL process can be associated with a single source, or a plurality of sources. The different sources, ETL system elements and storage devices can utilize separate servers that are connected by a communication network to facilitate data transfer and storage. System operation can be managed by one or more data processors to provide automated control of data management operations.

In this manner the warehouse adds value to operational business applications. The warehouse may be built around a carefully designed data model that transforms production data from a high speed data entry design to one that supports high speed retrieval. This improves data quality, by providing consistent codes and descriptions, and possibly flagging bad data. A preferred embodiment of the invention uses a derived surrogate key in which an identifier is formed from field entrees in the source table in which transaction data has been positioned. Different combinations of fields can be employed to generate derived surrogate keys depending on the nature of the data and the fields in use for a given data warehouse. It is generally preferred to use a specific combination of fields, or a specific formula, to form the derived surrogate keys for a particular data warehouse. This provides for data consistency and accuracy, and avoids the look-up operations commonly used in generating surrogate keys in existing data warehouses. Preferred embodiments of the invention utilize the derived surrogate key methodology to provide faster access to more complex data systems, such as the merger of disparate source data into a single warehouse.

A preferred embodiment of the invention uses the advantages provided by the derived surrogate key methodology in a hierarchical structure that uses a hierarchy table with a plurality of customer dimensions associated with a plurality of levels of an interim table. As hierarchy reporting requirements change it is no longer necessary to alter the dimension of the hierarchy table, as the interim table can be altered to provide for changed reporting requirements. Thus, a preferred method of the invention includes altering the interim table to provide for a change in reporting without the need for changing of each dimension. A preferred embodiment includes altering a rolling format which can include, for example, resetting the offset distance to identify which level in an interim table is used to retrieve the appropriate data. Thus, preferred methods involve setting the parameters such as the number of levels to be traversed in order to populate the interim table with an ETL tool. The interim table is then connected to the fact table and the dimension table to enable the generation of reports. The interim table can comprise a plurality of rows and a plurality of columns to provide a multidimensional array of fields in which keys are stored. Various dimensions of this key table can be extended to accommodate different reporting formats or the addition of additional data sources. A preferred embodiment operates to populate the fields of this key table with derived surrogate keys associated with each distinct data source, for example. This system can operate as an in-memory system with a cloud computing capability to support real time data management and analysis functions.

### BRIEF DESCRIPTION OF THE DRAWINGS

FIG. 1 is a high level representation of a data warehouse design used in certain embodiments, including a source system feeding the data warehouse and being utilized by a business intelligence (BI) toolset, according to an example embodiment.

FIG. 2A is an exemplary computing device which may be programmed and/or configured to implement certain processes described in relation to various embodiments of the present disclosure, according to an example embodiment.

FIG. 2B illustrates a networked communication system for performing multi-source data warehousing operations.

FIG. 3 illustrates an example database topology for pulling data from multiple data sources using an Extract, Transform, and Load (ETL) software tool, according to an example embodiment.

FIG. 4 illustrates an example of a database topology for creating a separate Central Repository (CR) for each of the separate data sources that uses a separately maintained ETL process, according to a preferred embodiment.

FIG. 5 illustrates an example of the separate business subjects (data marts) that may be included in the data warehouse, according to an example embodiment.

FIG. 6 illustrates an Accounts Receivable (AR) business subject (data mart) that may be included in the data warehouse, according to an example embodiment.

FIG. 7 illustrates an example embodiment to move data from the separate source transactional data stores into the AR Data Mart Fact table and the subordinate source specific extension tables, according to an example embodiment.

FIG. 8 illustrates an example embodiment to move data from the separate source transactional data stores into the Data Mart Fact Header table associated with each data source, according to an example embodiment.

FIG. 9 illustrates a method of creation and usage of system generated surrogate keys according to prior art.

FIG. 10A is a flow diagram depicting examples steps in a derived numeric surrogate key creation process, according to an example embodiment.

FIG. 10B illustrates a preferred method of forming a derived surrogate key.

FIG. 10C is a flow diagram depicting example steps in a derived surrogate key creation process without performing a lookup operation, according to an example embodiment.

FIG. 10D is a flow diagram depicting example steps in a derived surrogate key creation process without performing a lookup operation, according to an example embodiment.

FIG. 11A illustrates a flow diagram for forming a derived character surrogate key in accordance with preferred embodiments of the invention.

FIG. 11B illustrates a method of creation and usage of simple derived numeric surrogate keys based on application data in certain embodiments.

FIG. 12A illustrates a flow diagram for forming a derived multiple field numeric surrogate key in accordance with preferred embodiments of the invention.

FIG. 12B illustrates a method of creation and usage of simple derived character surrogate keys based on application data in certain embodiments.

FIG. 13A is a flow diagram for forming a derived multiple field character surrogate key in accordance with preferred embodiments of the invention.

FIG. 13B illustrates the method of certain embodiments for creating and using derived complex numeric surrogate keys based on application data.

FIG. 14A is a flow diagram for forming a derived surrogate key with a combination of numeric and character natural keys in accordance with preferred embodiments of the invention.

FIG. 14B illustrates the method of certain embodiments for creating and using derived complex character surrogate keys based on application data.

FIG. 15 illustrates the method of certain embodiments for creating and using a source control.

FIG. 16 is a flow diagram depicting a method for providing multisource control in certain embodiments.

FIG. 17A illustrates the method of certain embodiments for using audit controls.

FIG. 17B illustrates an ETL process for moving a source system table into a dimension table.

FIG. 18A-D illustrate various prior art methods of utilizing hierarchies.

FIG. 19A illustrates the method of utilizing hierarchies in certain of the embodiments, overcoming certain of the deficiencies of the structures of FIGS. 18A-D.

FIG. 19B is a flowchart of an exemplary method of generating an interim table.

FIG. 19C is a flowchart of an exemplary method of using an interim table.

FIG. 19D illustrates a method for traversing an hierarchical table.

FIG. 20A illustrates a method used in certain embodiments to build a dates dimension.

FIG. 20B illustrates a flow diagram for forming a dates dimension.

FIG. 21 is a flow diagram depicting a method used in certain embodiments to create a dates dimension.

FIGS. 22A-B show an example of the dates dimension in certain embodiments.

FIG. 23 is a flow diagram depicting steps in a process for providing a cross-module linkages table.

FIG. 24 is a process flow diagram illustrating a method for traversing a cross-module linkages table to generate reports.

FIG. 25 illustrates a method of forming a derived composite key.

FIG. 26A illustrates a process flow for forming a dates pattern table.

FIG. 26B illustrates variables in the process flow sequence of FIG. 26A.

FIGS. 26C-26G illustrate flow diagram for forming a dates pattern.

FIGS. 27A-27E illustrate methods for periodic dates pattern information processing.

FIGS. 28A-28G illustrate methods of processing dates information in accordance with preferred embodiments of the invention.

### DETAILED DESCRIPTION OF THE INVENTION

Preferred embodiments of the invention include systems and methods for improving the speed and efficiency of data warehouse operations. Some embodiments support data warehouse operations for multiple different data sources. In some embodiments, an ETL process is modified to perform a joined indexing operation which may reduce the number of lookup requests required, for example. Certain embodiments contemplate a date dimension and hierarchical data structure which improve operation speed. Still other embodiments contemplate structural organizations of biographical fact tables to better improve data access.

Current data warehouses may not provide a facility to capture where a particular piece of information comes from, and if they do, they do not incorporate that information into the key structure of their data warehouse data. The embodiments disclosed here provides a mechanism whereby a unique data source identifier is included both on the data row as a unique field for every row in both the Central Repository and Data Mart tables, and as part of the unique row identifier field for every row in the Data Mart tables.

Conventional data warehouses may include and use the source system's artificial, or system generated surrogate keys (ASK) when building the dimension tables based on the biographical tables in the source system. The ASK normally is a numeric, system-generated, field that has no meaning for the business. When the fact table is being built some systems use the natural key elements stored in the transactional tables to retrieve the artificial surrogate key value from the dimension. This conventional method can have a negative impact on the efficiency of fact table load process as each transaction row entails an additional query to the dimension to pull back the ASK. The embodiments disclosed here solves this problem by providing a Derived Surrogate Key (DSK) built by combining a source system identifier and the dimension table's natural key.

Business organizations and entities often use Enterprise Resource Planning (ERP) systems to store and manage data at various business stages. ERP systems typically support business needs and stages such as product planning, cost and development, manufacturing, marketing and sales, inventory management, shipping and payment, and the like. Business entities have the need to insert, update, delete, or purge data from their ERP systems, and many of those ERP systems do not effectively capture such information, especially when purging data. The embodiments disclosed here provide both indicator and date fields to capture when data is inserted, updated or deleted, and a date field when data is purged from the source ERP systems.

Business organizations want to be able to report on many different aspects of a single date, such as the aging aspects, or where that date would fall on the Fiscal Calendar, or Corporate Calendar. Dates dimensions in current data warehouses provide basic information regarding dates. The embodiments disclosed here provide a Dates dimension that indicates many permutations of each date in a company's calendar, such as Accounts Payable and Accounts Receivable Aging information, Rolling Date information, Fiscal, Corporate and Calendar date information, Sales Day and Work Day in Week, Period and Year, as well as Financial Reporting Report Titles associated with that date.

Business organizations further want to be able to report on information that is available across disciplines within their business. They want to be able to glean such information as Order-to-Cash, Requisition-to-Hire, etc. The embodiments disclosed here provide a method wherein the keys within disparate transaction tables are joined together in a common linkage table.

Business organizations also want to be able to access all of the information related to their transactions, and they want to be able to easily find related transactional information. They want to be able to summarize their transaction information in an expedient manner. The traditional industry approach is to provide those data fields deemed appropriate for a given transaction; they do not provide all data fields associated with a transaction. The embodiments disclosed herein provide all of the biographical data fields associated with a given transaction record.

Business organizations also want to be able to report on information that is available across disciplines within their business. They want to be able to report on business critical information. They also want to be able to traverse their data from one discipline to another in a seamless manner, such as traversing from a Sales Order to determine what Billing or Accounts Receivable information is associated with the Order, and conversely, to traverse from an Accounts Receivable Invoice to related Sales Order(s) information. In conventional data warehouses, this facility is not readily available and to build such a method is often an arduous and time-consuming development task. The embodiments disclosed here provide a method whereby the transactional record key fields from each pertinent module are married to related transactional record key fields within a single hybrid table.

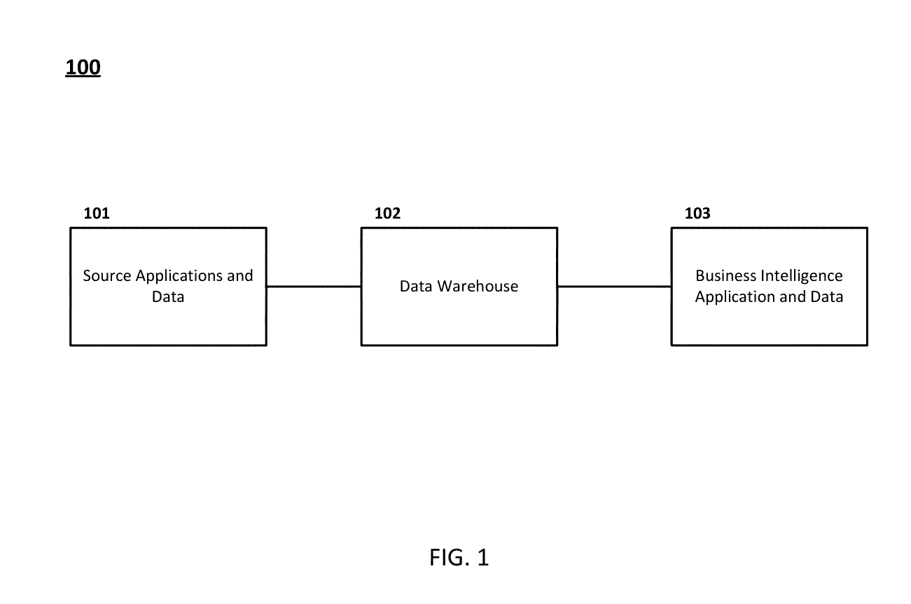

FIG. 1 depicts a high level representation of a data warehouse design 100 used in certain embodiments. A source system 101, such as an Online Transaction Processing system (OLTP), may feed data to a data warehouse 102. A business intelligence tool 103 can then use the data from the data warehouse to provide the business community or other organizations with actionable information.

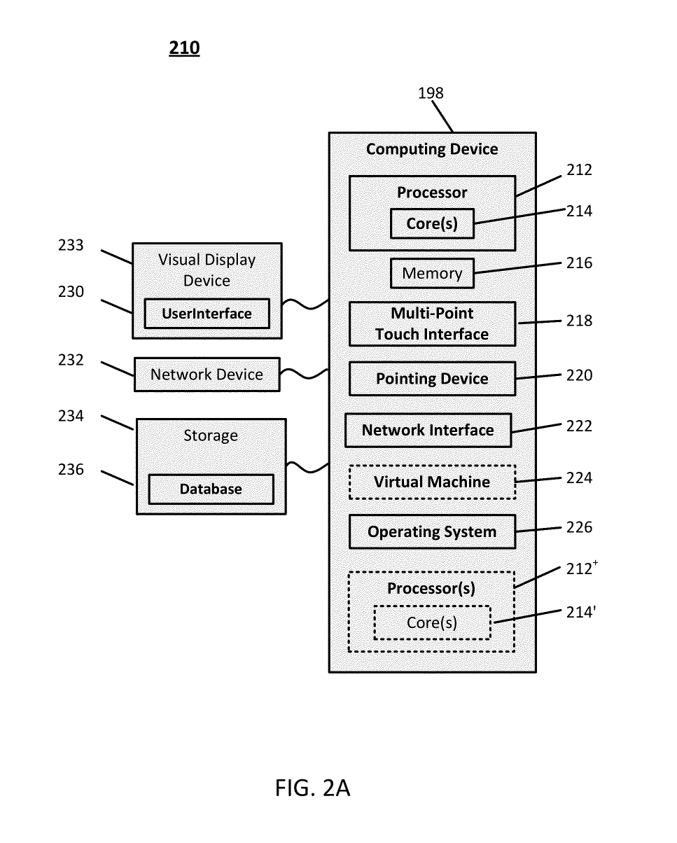

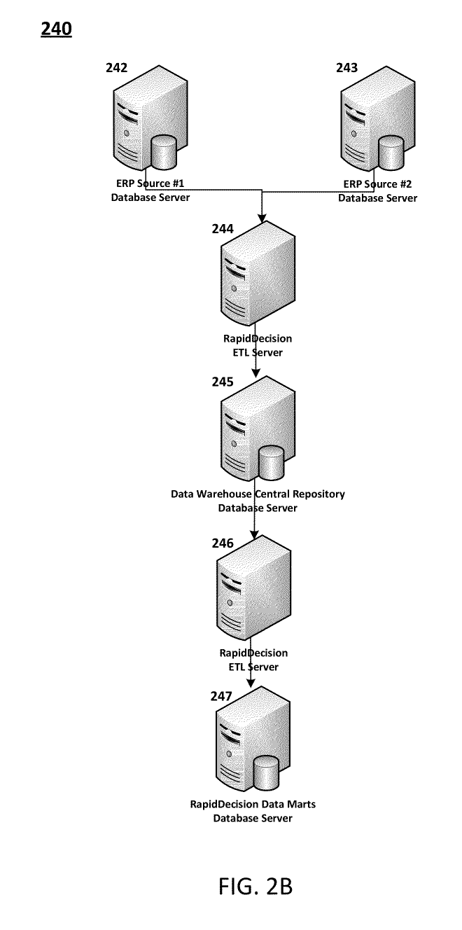

FIG. 2A is a block diagram of an exemplary computing device 210 that can be used in conjunction with preferred embodiments of the invention. The computing device 210 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 216 included in the computing device 210 may store computer-readable and computer-executable instructions or software for interface with and/or controlling an operation of the scanner system 100. The computing device 210 may also include configurable and/or programmable processor 212 and associated core 214, and optionally, one or more additional configurable and/or programmable processing devices, e.g., processor(s) 212′ and associated core(s) 214′ (for example, in the case of computer systems having multiple processors/cores), for executing computer-readable and computer-executable instructions or software stored in the memory 216 and other programs for controlling system hardware. Processor 212 and processor(s) 212′ may each be a single core processor or multiple core (214 and 214′) processor.

Virtualization may be employed in the computing device 210 so that infrastructure and resources in the computing device may be shared dynamically. A virtual machine 224 may be provided to handle a process running on multiple processors so that the process appears to be using only one computing resource rather than multiple computing resources. Multiple virtual machines may also be used with one processor.

Memory 216 may include a computer system memory or random access memory, such as DRAM, SRAM, EDO RAM, and the like. Memory 216 may include other types of memory as well, or combinations thereof.

A user may interact with the computing device 210 through a visual display device 233, such as a computer monitor, which may display one or more user interfaces 230 that may be provided in accordance with exemplary embodiments. The computing device 210 may include other I/O devices for receiving input from a user, for example, a keyboard or any suitable multi-point touch interface 218, a pointing device 220 (e.g., a mouse). The keyboard 218 and the pointing device 220 may be coupled to the visual display device 233. The computing device 210 may include other suitable conventional I/O peripherals.

The computing device 210 may also include one or more storage devices 234, such as a hard-drive, CD-ROM, or other computer readable media, for storing data and computer-readable instructions and/or software to implement exemplary processes described herein. Exemplary storage device 234 may also store one or more databases for storing any suitable information required to implement exemplary embodiments. For example, exemplary storage device 234 can store one or more databases 236 for storing information. The databases may be updated manually or automatically at any suitable time to add, delete, and/or update one or more items in the databases.

The computing device 210 can include a network interface 222 configured to interface via one or more network devices 232 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 222 may include a built-in network adapter, network interface card, PCMCIA network card, card bus network adapter, wireless network adapter, USB network adapter, modem or any other device suitable for interfacing the computing device 210 to any type of network capable of communication and performing the operations described herein. Moreover, the computing device 210 may be any computer system, such as a workstation, desktop computer, server, laptop, handheld computer, tablet computer, or other form of computing or telecommunications device that is capable of communication and that has sufficient processor power and memory capacity to perform the operations described herein.

The computing device 210 may run any operating system 226, such as any of the versions of the Microsoft® Windows® operating systems, the different releases of the Unix® and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 226 may be run in native mode or emulated mode. In an exemplary embodiment, the operating system 226 may be run on one or more cloud machine instances.

FIG. 2B illustrates a server system that utilizes private or public network communication links such that the system can implement one or more functionalities disclosed herein, including multi-source data processing. ERP Source 242 and ERP Source 243 are in communication with ETL server 244. The ETL server 244 is in communication with Central Repository and Database server 245, which is in turn in communication with another ETL server 246. The ETL server 246 is in communication with Data Marts and Database server 247. The functionalities implemented in each component and the data flow between the components of FIG. 2B are described in detail below.

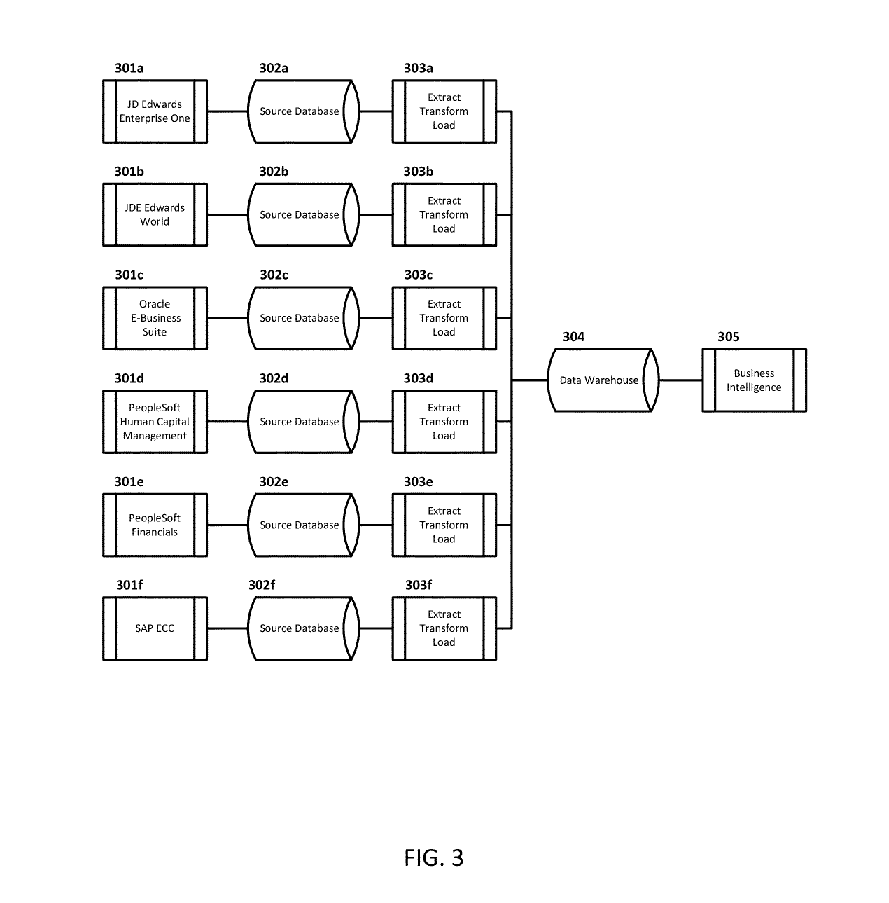

FIG. 3 illustrates a database topology for pulling data from multiple data sources (for example, Enterprise Resource Planning (ERP) systems) using an Extract, Transform, and Load (ETL) software tool. The ETL tool may obtain data from each appropriate source, including whatever data management systems are in use by a business entity. Example embodiments support a variety of data sources 301a-f, such as JD Edwards Enterprise One, JD Edwards World, Oracle® E-Business Suite, PeopleSoft Human Capital Management, PeopleSoft Financials, and SAP® ECC, for example. Data sources 301a-f can feed the data warehouse information. Each of the sources may be housed on a separate and distinct database 302a-f. Separate and distinct ETL processes 303a-f may be used to extract the data from each separate source system application, edit it, assign easy-to-understand names to each field, and then load the data into the data warehouse 304 where it can be used by the BI toolset 305.

Oracle® E-Business Suite (EBS) may be supported by some embodiments. EBS is available from Oracle® Corporation and originally started as a financials package. Over times, it has evolved to be more as it now also supports, sales and distribution, manufacturing, warehouse and packaging, human resources, and other data packages. It has evolved into an Enterprise Resource Planning (ERP) system and a Material Requirements Planning (MRP) system. Another source supported by some embodiments are sources provided by PeopleSoft (PS). PeopleSoft sources provided separate code base between its Financials and Human Capital Management products. It also provides separate databases for these two features. Yet another source supported by some embodiments of the present invention are sources provided by JD Edwards (JDE). The original code-base for JD Edwards systems was written for an iSeries® IBM® eServer™ (formerly known as an AS/400®) where the native database was integrated into the operating system and hardware as one. Particular deviations from the industry standard in JD Edwards sources include Table Name and Field Names which cannot be longer than 8-10 bytes. Also, the product evolved into a secondary code base known as Enterprise One. Therefore, currently there are two separate code bases—JD Edwards World (still on the iSeries®—DB2 database) and Enterprise One (Windows®—SQL Server®). Another data source supported by some embodiments is ERP Central Component (ECC) provided by SAP®. The ECC system operates in different languages using an acronym coding and naming convention.

The data sources supported by some of the embodiments disclosed here are different from each other in various ways. For example, EBS, PS, JDE, and ECC, each have different code bases, different table structures, different naming conventions, and the like. Because the table name, field names, and other components of these data sources have been developed independently and separate from each other, the table containing general customer information (a Customer Table), for example, is not named the same across the data sources. For example, in JDE this table is named F0301, while EBS names this table HZ_ORGANIZATIONS_ALL, and PS names it PS_COMPANY_TBL.

Some of the embodiments disclosed here provide methods and systems to bring together the common elements between the various data sources and align them so that users can utilize one system for interacting with data from various data sources. For example, the methods and systems described in the present application can determine the table that contains customer information and the field that contains the customer number for each data source, and aligns them and stores them in a table that clearly identifies the customer table and the customer number field. Additionally, each data source also implements different ways of ascertaining the keys for its tables. For example, EBS uses only system assigned numeric identifiers. On the other hand, PS uses multi-field, multi-format concatenated keys. JDE uses a mixture of formats in their key identifiers. In addition to aligning data from various data sources, the systems and methods disclosed herein also generates keys in a uniform manner for the tables. The key generation methodology is described below in more detail.

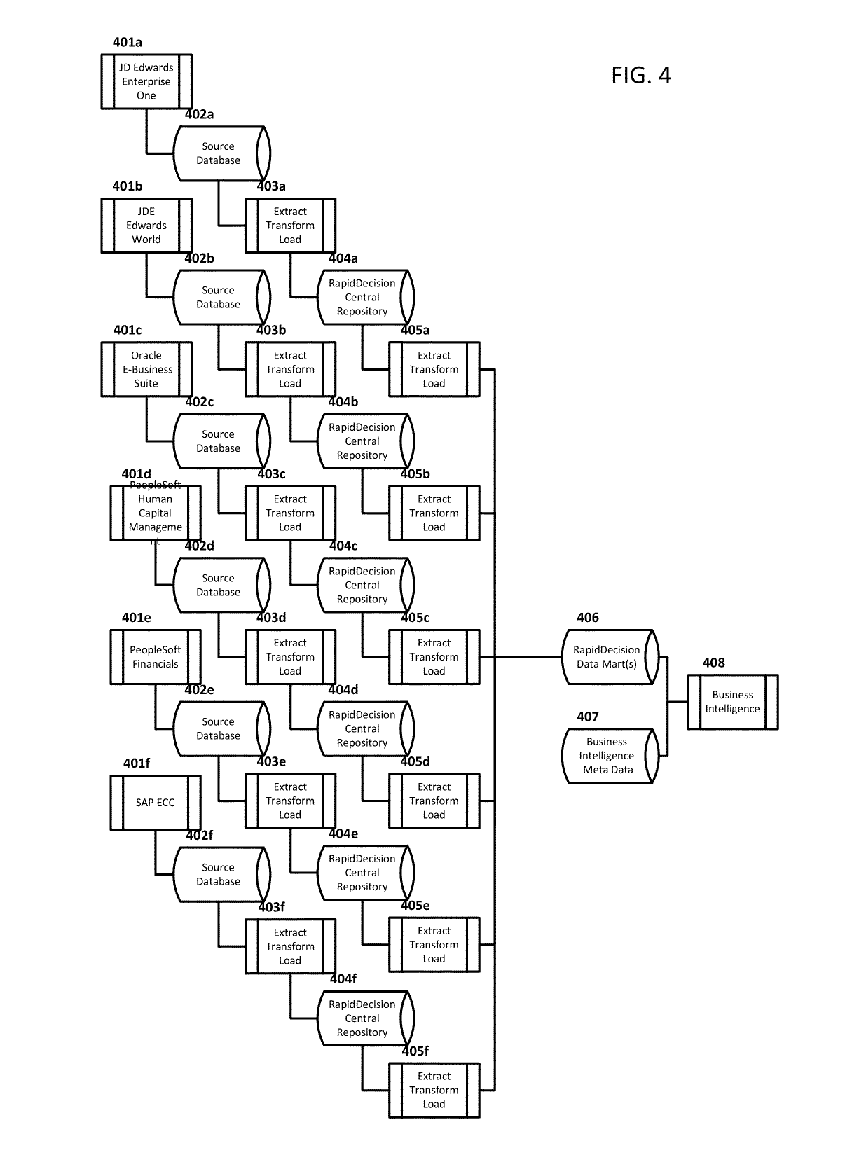

FIG. 4 illustrates an example database topology for creating a separate Central Repository (CR) for each of the separate sources that uses a separately maintained ETL process. FIG. 4 illustrates a sampling of the supported data sources 401a-f that can provide data to the data warehouse, the source databases 402a-f, the ETL processes 403a-f, such as SAP® Data Services ETL processes. ETL processes 403a-f may provide information to the Central Repository (CR) 404a-f. In some embodiments, the data that is extracted from the source system and loaded into the CR may be moved with minimal transformations, whereby table and field names can be modified so that they are more meaningful to a wider audience, and dates may be transformed from a numeric to date format. Every row and every field may be loaded from the required source tables to the related CR tables. Processes 403a-f are each developed uniquely for each of the sources 402a-f. Additional ETL processes 405a-f can extract, transform and load the appropriate data from the CR tables 404a-f into the data marts 406. During operation of these ETL processes many complex transformations (for example, hierarchical derivations, complex profit analysis, parsing of strings into components) occur that improve the flexibility of the tables in the data marts allowing for the creation of the metadata 407. Metadata 407 are needed by the BI tool's 408 reports and other information delivery mechanisms. Certain embodiments include a sample set of metadata for each of the underlying data marts that are offered in the data warehouse.

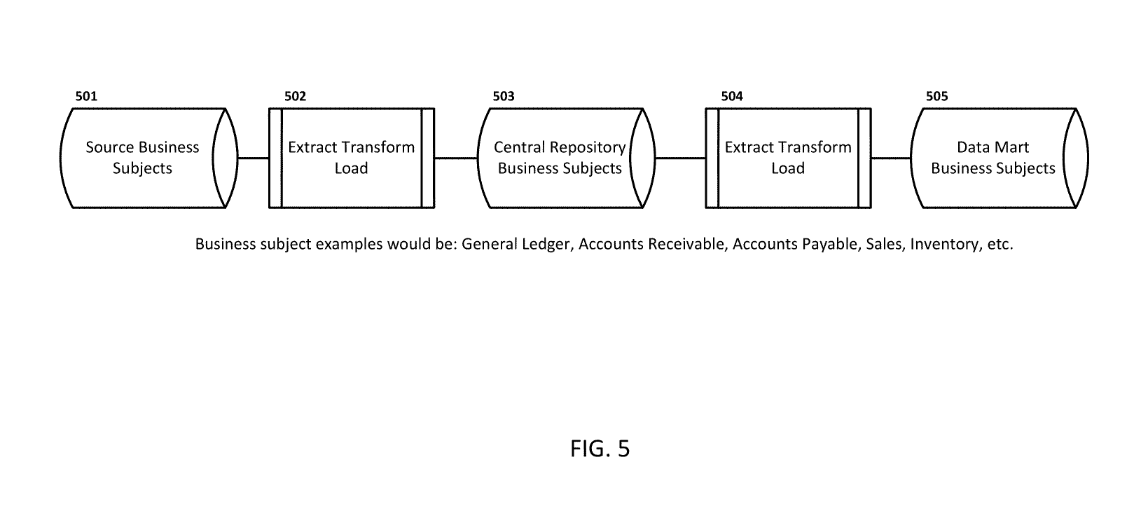

FIG. 5 illustrates a sample of the separate business subjects (data marts) 505 that can be created in the data warehouse of certain embodiments. Separate data marts may be associated with each of the separate business subjects, or “Subject Areas”, such as, e.g., Accounts Payable, Accounts Receivable, General Ledger, Inventory and Sales, and the like. In most cases, individual data marts contain data from a single subject area such as the general ledger, or optionally, the sales function.

Certain embodiments of the data warehouse perform some predigesting of the raw data in anticipation of the types of reports and inquiries that will be requested. This may be done by developing and storing metadata (i.e., new fields such as averages, summaries, and deviations that are derived from the source data). Certain kinds of metadata can be more useful in support of reporting and analysis than other metadata. A rich variety of useful metadata fields may improve the data warehouse's effectiveness.

A good design of the data model around which a data warehouse may be built, may improve the functioning of the data warehouse. The names given to each field, whether each data field needs to be reformatted, and what metadata fields are processed, or calculated and added, all comprise important design decisions. One may also decide what, if any, data items from sources outside of the application database are added to the data model.

Once a data warehouse is made operational, it may be desirable for the data model to remain stable. If the data model does not remain stable, then reports created from that data may need to be changed whenever the data model changes. New data fields and metadata may need to be added over time in a way that does not require reports to be rewritten.

The separate ETL process tools 502 may read data from each source application 501, edit the data, assign easy-to-understand names to each field, and then load the data into a central depository 503 and a second ETL process 504 can load into data marts 505.

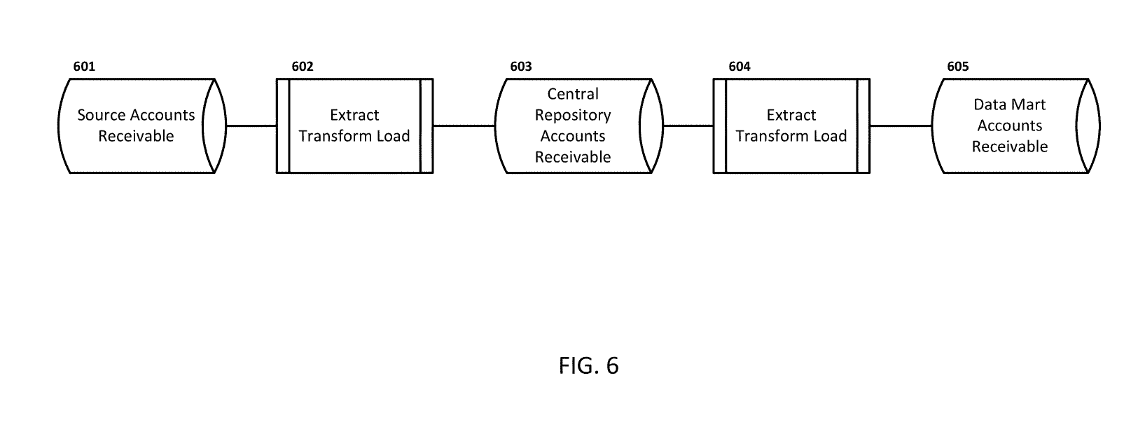

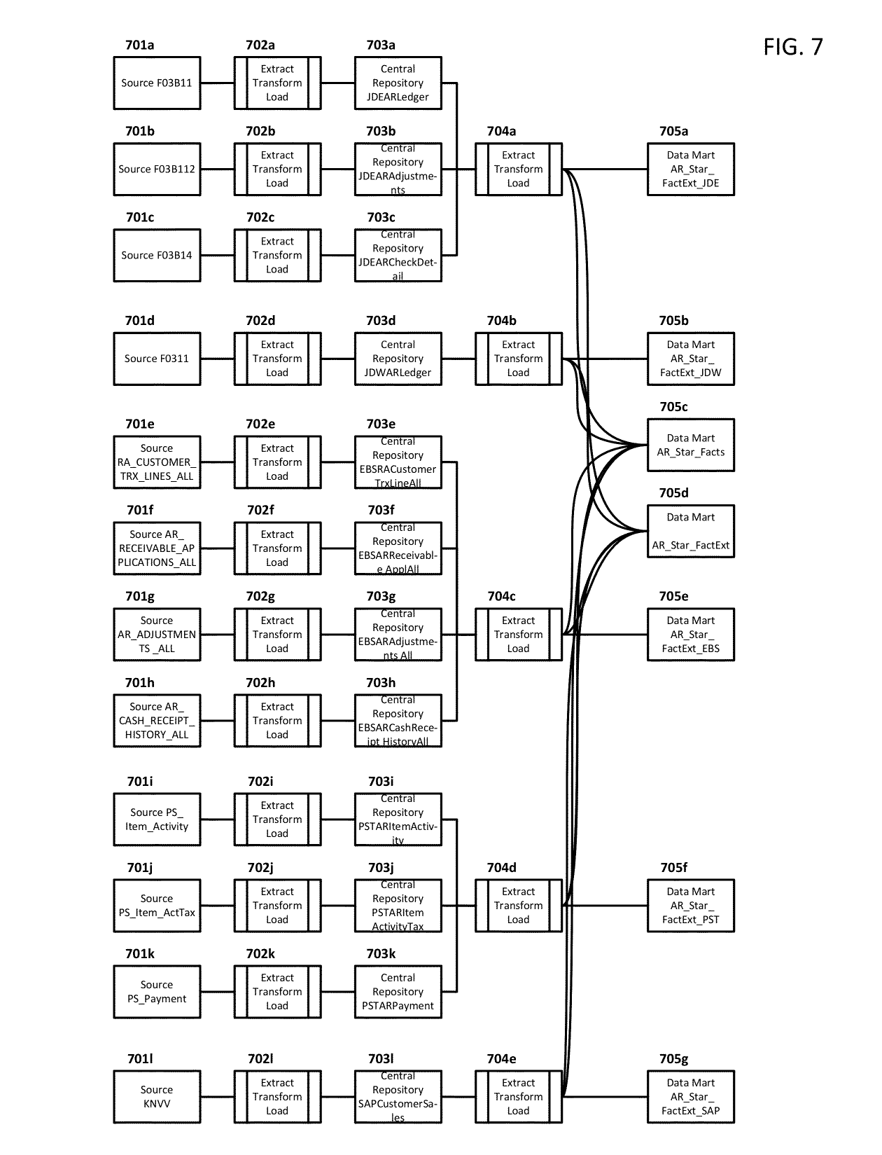

FIG. 6 illustrates how the Accounts Receivable (AR) business subject (data mart) 603 may be included in the data warehouse of certain embodiments using source data 601, a first ETL process 602 to load the data into repository 603, and a second ETL process to load into data marts 605.

FIG. 7 illustrates how certain embodiments move data from the separate source ERP transactional detail data stores 701a-7011 into the AR Data Mart Fact table 705a-705g and the subordinate ERP specific extension tables using load 702a-7021 storage 703a-7031 and load 704a-704e steps. The Fact tables house, the composite key linkages to the dimensions, the most widely utilized measures, as well as key biographical information. Any of the fields from the source transaction table, that are not included in the Fact table, are carried forward into the related ERP's extension table. This allows the business to query on any of the data that is not included in the facts, and is made readily available.

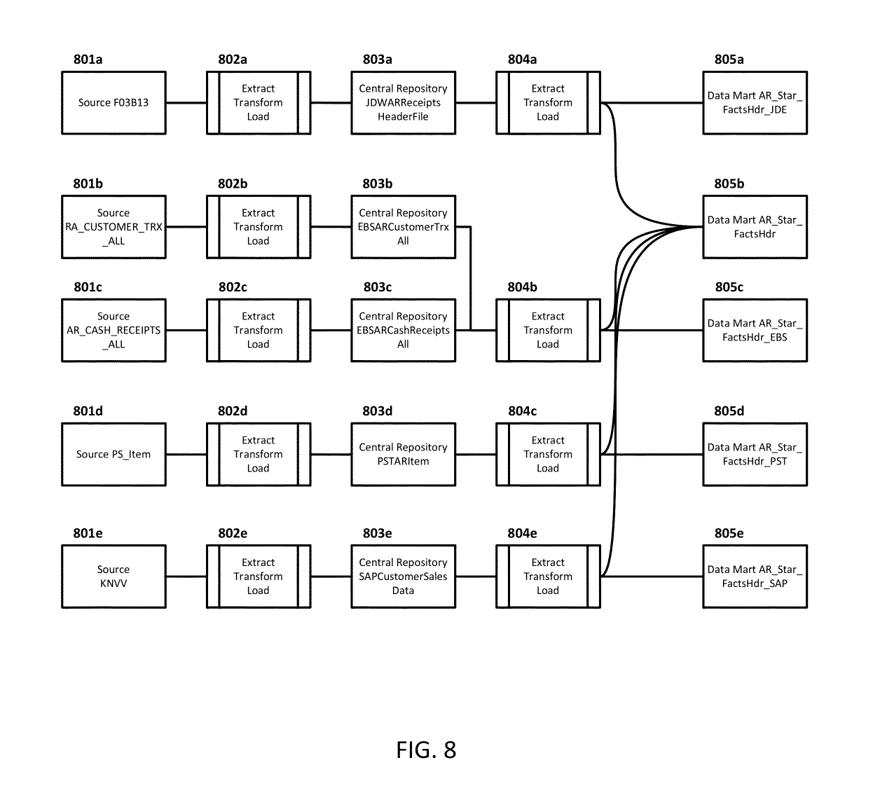

FIG. 8 illustrates how certain embodiments move data from the separate source ERP transactional data stores 801a-801e into the Data Mart Fact Header table 805a-805e associated with each data source.

Conventional data warehouses may include and use the source system's artificial, or system generated, surrogate keys (ASK) when building the dimension tables based on the biographical tables in the source system. The ASK may be a numeric, system-generated, field that has no meaning to a business organization. When the fact table is being built some systems will use the natural key elements stored in the transactional tables to retrieve the surrogate key value from the dimension. This can have a negative impact on the efficiency of fact table load process as each transaction row will entail an additional query to the dimension to pull back the ASK.

Certain embodiments disclosed herein, by contrast, utilize a Derived Surrogate Key (DSK), composed from other fields such as with the natural key of the biographical table in the source system. The natural key may include one to many fields in the source table. These same fields may be normally included in the transactional table and as such can join directly to the dimension table to easily retrieve desired biographical information for reporting purposes. The DSK provides data consistency and accuracy. The traditional ASK does not provide a true level of consistency as the biographical data can change over time and can often entail a newly generated surrogate key.

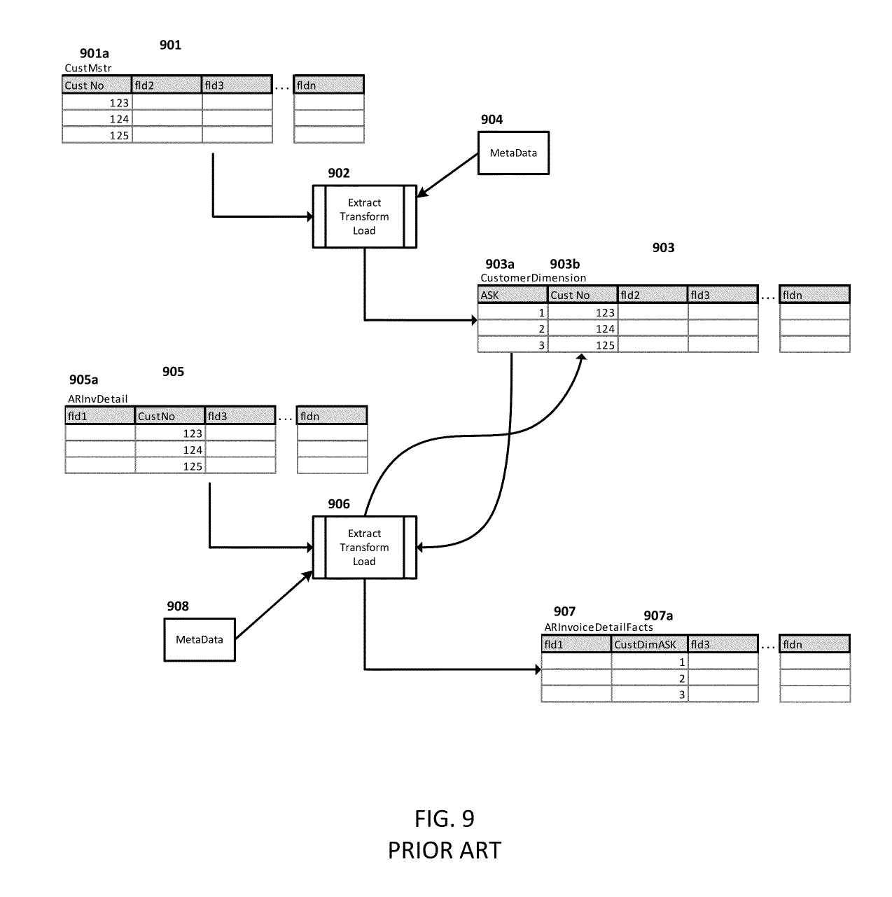

FIG. 9 illustrates a conventional method of formation and usage of system generated surrogate keys (ASK). The method uses system generated ASKs when populating the dimension's surrogate key value into the transaction related fact table. The AR module's customer master table 901 is propagated into the customer dimension 903 using an ETL process 902. Metadata 904 may dictate the operation of ETL process 902. During the ETL process the customer number 901a may be brought over to the dimension, and an Artificial Surrogate Key 903a may be generated to identify the corresponding row in the customer dimension 903. When the AR transaction table 905 that houses the customer number is propagated into the AR Fact table 907, the ETL process 906 performs a lookup (as illustrated by the arrows) into the customer dimension 903 to retrieve the ASK 903a for storage in the fact table 907a. While this may be an efficient method for BI reporting purposes, the ETL fact table load process can be resource intensive, especially when there are a large number of rows in the source transaction table, and the lookup has to be performed for each row to bring in the ASK.

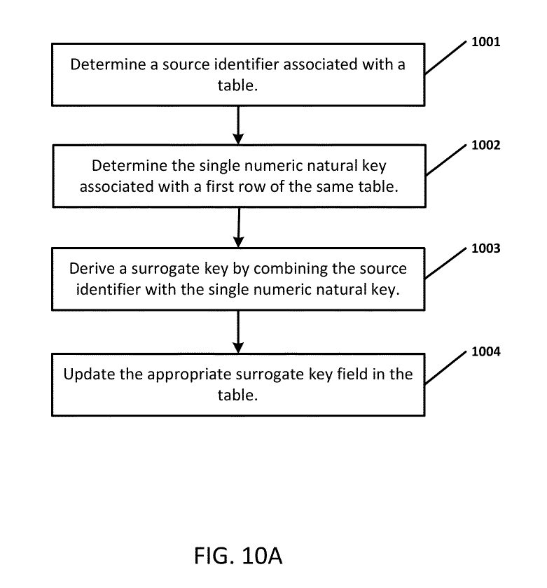

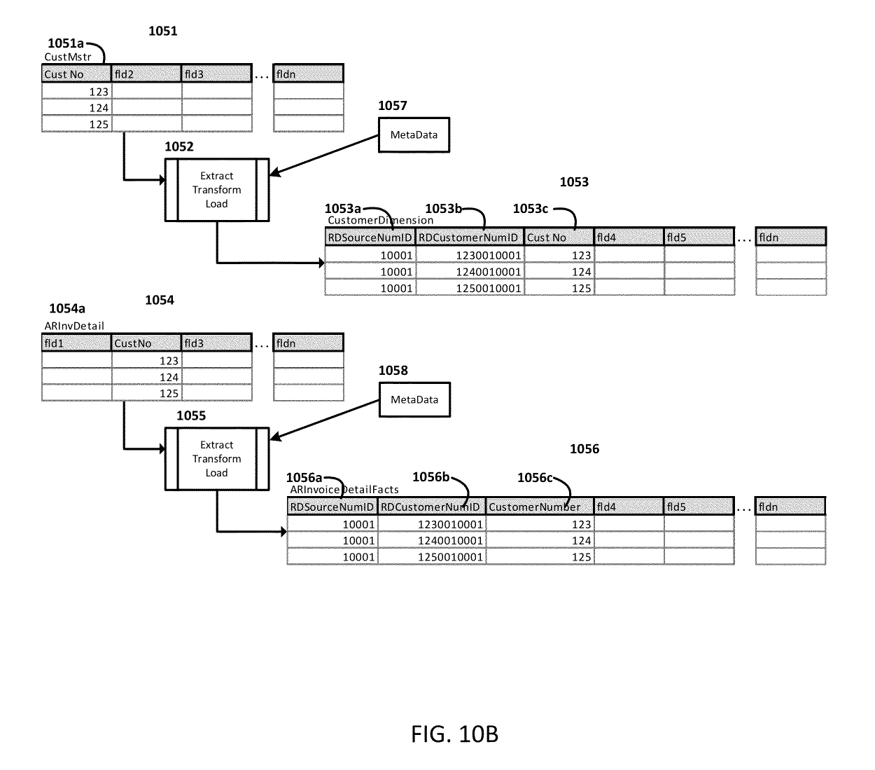

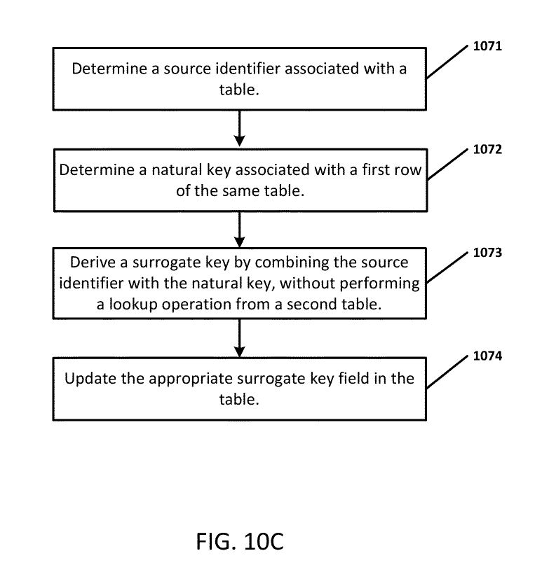

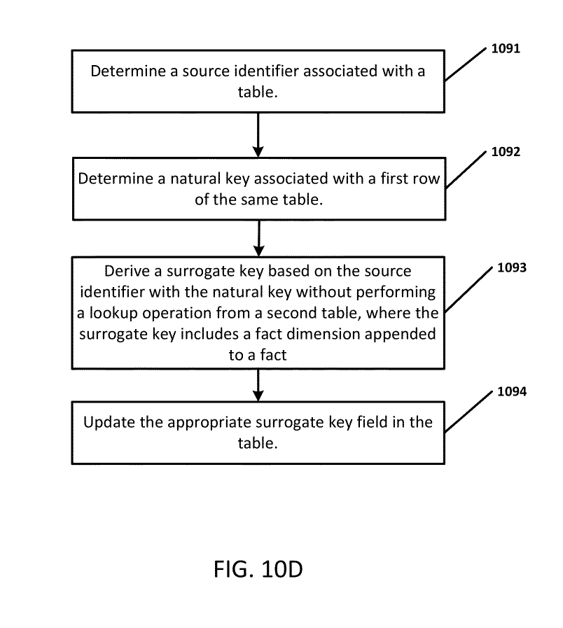

FIG. 10A is a flow diagram depicting certain steps in a derived numeric surrogate key formation process. At block 1001 the system may determine a source identifier field associated with a table. At block 1002 the system may determine the single numeric, natural key associated with a first row of the same table. One will recognize that the first row may appear anywhere in the tables. At block 1003 the system may formulate an identifier, such as a derived surrogate key, based on the first field value and the second field value. The identifier may be formulated by combining the first and second values. At block 1004 the system may then update the identifier in the table. These operations may be performed via an ETL process configured using instructional metadata.

FIG. 10B illustrates a method for creating and using derived surrogate keys based on application data in certain embodiments, as generally described in FIG. 10A. This method may overcome the need for as many lookups as illustrated in the conventional method of FIG. 9. The method may generate Derived Surrogate Keys (DSK) for a single numeric field identifier to create a more efficient load process for the fact tables. When building the dimension table 1053 the ETL process 1052, such as a SAP® Data Services ETL process, for example, is modified to form a DSK field based on the source of the dimension table 1051 and the dimension's natural identifier. ETL process 1052 may be configured to perform this operation using metadata 1057. In this example, the DSK field 1056b may be comprised of a natural dimension identifier, in this example, Cust No. 1053c and the RDSourceNumID 1053a. The RDSourceNumID field 1053a is discussed in greater detail below in reference to source controls. When building the fact table 1056, the ETL process 1055, which may also be SAP® Data Services ETL process, that is adapted to create DSKs based on the dimension values contained within the source transaction table 1054. The DSKs 1056b can be in the same format as those in the dimension tables, RDSourceNumID 1056a and the dimension's natural identifier 1056c.

FIG. 10C is a flow diagram depicting certain steps in a derived surrogate key formation process without performing a lookup operation such as illustrated in the prior art example shown in FIG. 9. At block 1071 the system may determine a source identifier field associated with a table. At block 1072 the system may determine a natural key associated with a first row of the same table. One will recognize that the first row may appear anywhere in the tables. At block 1073 the system may formulate an identifier, such as a derived surrogate key, based on the first field value and the second field value without performing a lookup operation from a second table. The identifier may be formulated by combining the first and second values. At block 1074 the system may then update the identifier in the table. These operations may be performed via an ETL process configured using instructional metadata.

FIG. 10D is a flow diagram depicting certain steps in a derived surrogate key formation process without performing a lookup operation such as illustrated in the prior art example shown in FIG. 9. At block 1091 the system may determine a source identifier field associated with a table. At block 1092 the system may determine a natural key associated with a first row of the same table. One will recognize that the first row may appear anywhere in the tables. At block 1093 the system may formulate an identifier, such as a derived surrogate key, based on the first field value and the second field value without performing a lookup operation from a second table. The derived surrogate key comprises a fact dimension appended to a fact. The identifier may be formulated by combining the first and second values. At block 1094 the system may then update the identifier in the table. These operations may be performed via an ETL process configured using instructional metadata.

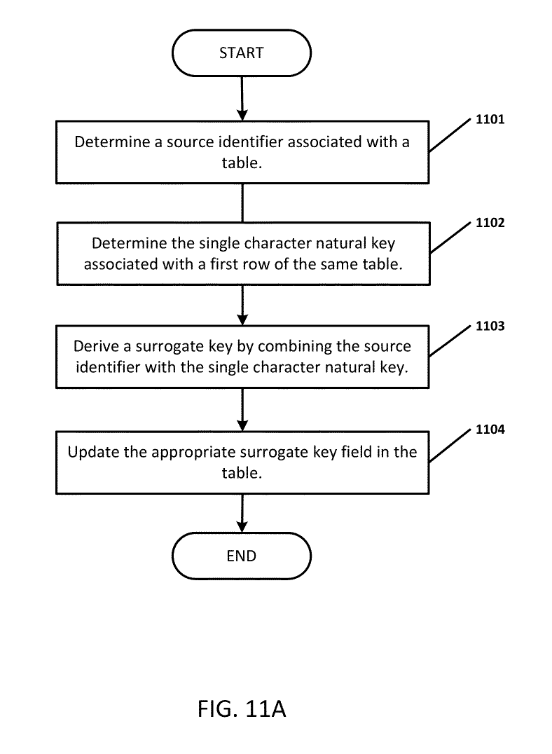

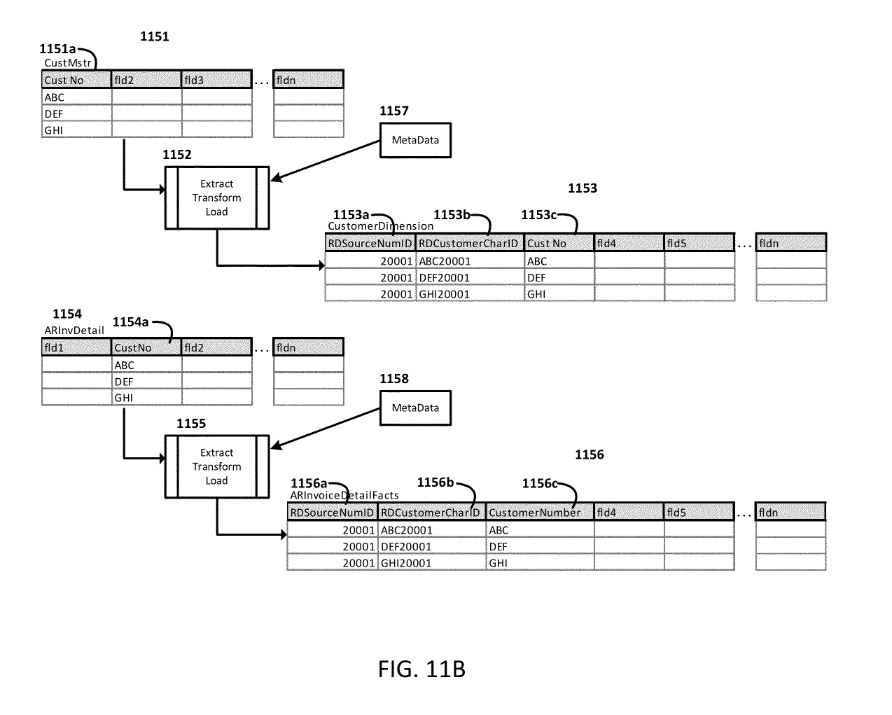

FIG. 11A is a flow diagram depicting certain steps in a derived character surrogate key formation process. At block 1101 the system may determine a source identifier field associated with a table. At block 1102 the system may determine a single character, natural key associated with a first row of the same table. One will recognize that the first row may appear anywhere in the tables. At block 1103 the system may formulate an identifier, such as a derived surrogate key, based on the first field value and the second field value. The identifier may be formulated by combining the first and second values. At block 1104 the system may then update the identifier in the table. These operations may be performed via an ETL process configured using instructional metadata.

FIG. 11B illustrates a method of creation and usage of derived surrogate keys based on application data in certain embodiments. In this embodiment, a single character field identifier customer number 1101a, 1103c, 1104a, 1106c may be used to create the DSK.

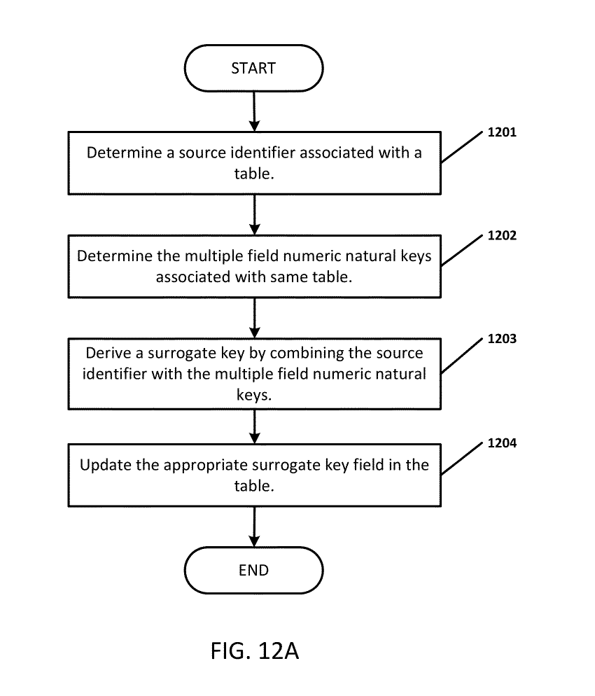

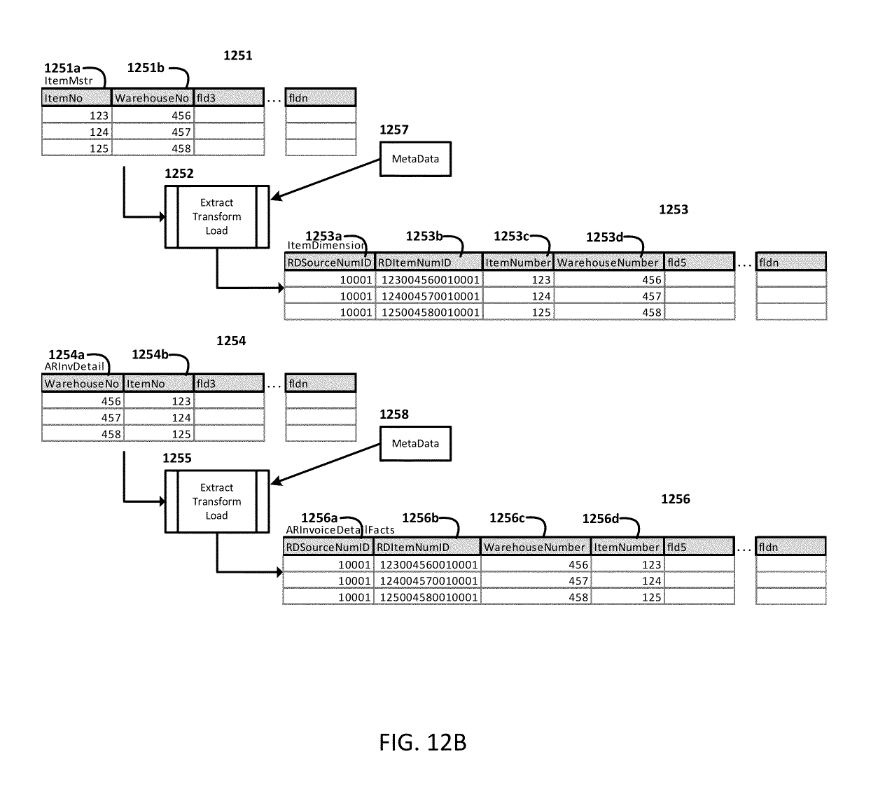

FIG. 12A is a flow diagram depicting certain steps in a derived multiple field numeric surrogate key formation process. At block 1201 the system may determine a source identifier field associated with a table. At block 1202 the system may determine the multiple field numeric, natural key associated with a first row of the same table. One will recognize that the first row may appear anywhere in the tables. At block 1203 the system may formulate an identifier, such as a derived surrogate key, based on the first field value and the second field value. The identifier may be formulated by combining the first and second values. At block 1204 the system may then update the identifier in the table. These operations may be performed via an ETL process configured using instructional metadata.

FIG. 12B shows the method of certain embodiments of forming derived surrogate keys (DSK) for a complex numeric field identifier in order to create a more efficient load process for the fact tables. When building the dimension table 1253 ETL process 1252, such as an SAP® Data Services product adapted for this purpose, can form a DSK field based on the source of the dimension table 1251 and the dimension's natural identifier. The DSK field will be comprised of the natural dimension identifier, in this example, ItemNumber 1253c and WarehouseNumber 1253d, and the RDSourceNumID 1253a. When building the Fact table 1256 the ETL process 1255 may also create DSKs based on the dimension values contained within the source transaction table 1254. The DSKs 1256b are in the same format as those in the dimension tables, RDSourceNumID 1256a and the dimension's natural identifier, in this case the ItemNo 1256d concatenated with the WarehouseNo 1256c concatenated with RDSourceNumID 1256a.

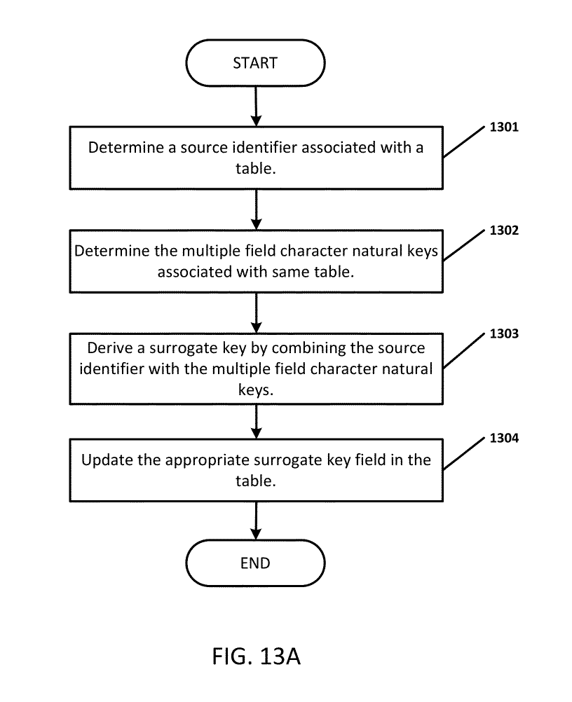

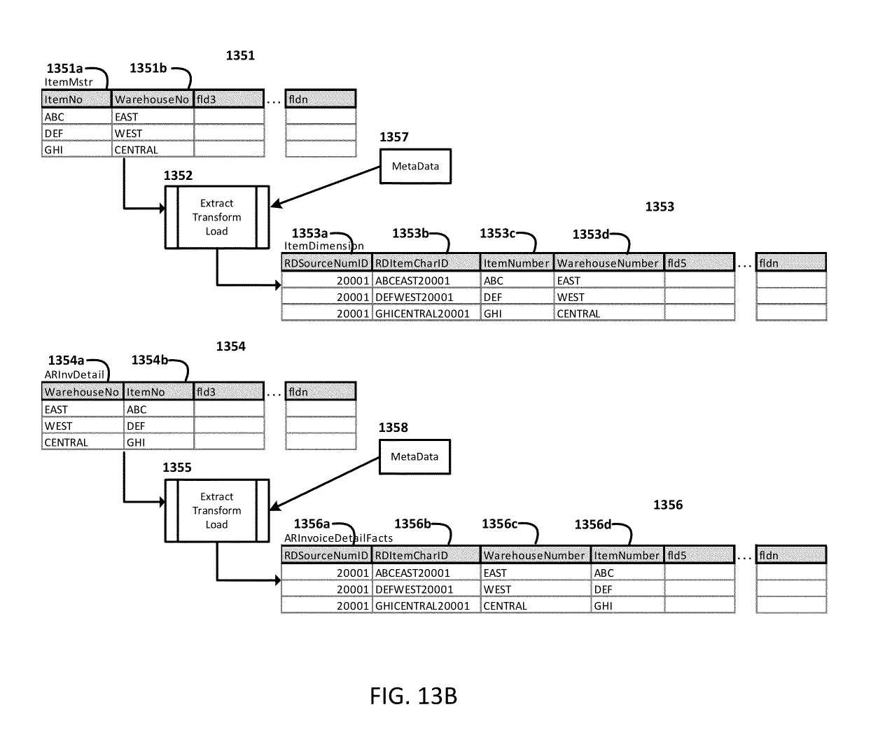

FIG. 13A is a flow diagram depicting certain steps in a derived multiple field character surrogate key formation process. At block 1301 the system may determine a source identifier field associated with a table. At block 1302 the system may determine the multiple field character, natural key associated with a first row of the same table. One will recognize that the first row may appear anywhere in the tables. At block 1303 the system may formulate an identifier, such as a derived surrogate key, based on the first field value and the second field value. The identifier may be formulated by combining the first and second values. At block 1304 the system may then update the identifier in the table. These operations may be performed via an ETL process configured using instructional metadata.

FIG. 13B shows the method of certain embodiments of creating Derived Surrogate Keys (DSK) for a complex character field identifier in order to create a more efficient load process for the fact tables. When building the dimension table 1353 the SAP® Data Services ETL process 1352, for example, is adapted to form a DSK field based on the source of the dimension table 1351 and the dimension's natural identifier. The DSK field will be comprised of the natural dimension identifier, in this example, ItemNumber and WarehouseNumber, and the RDSourceNumID When building the fact table 1356 the ETL process 1355 also creates DSKs based on the dimension values contained within the source transaction table 1354. The DSKs 1356b can be in the same format as those in the dimension tables, RDSourceNumID 1356a and the dimension's natural identifier, in this case the ItemNo 1356d concatenated with the WarehouseNo 1356c concatenated with RDSourceNumID 1356a.

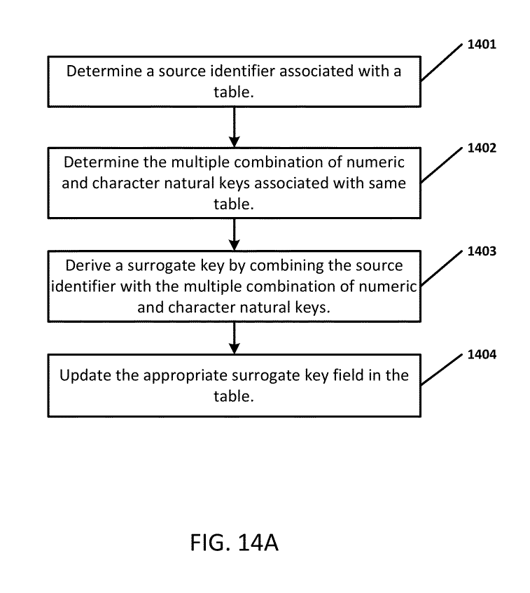

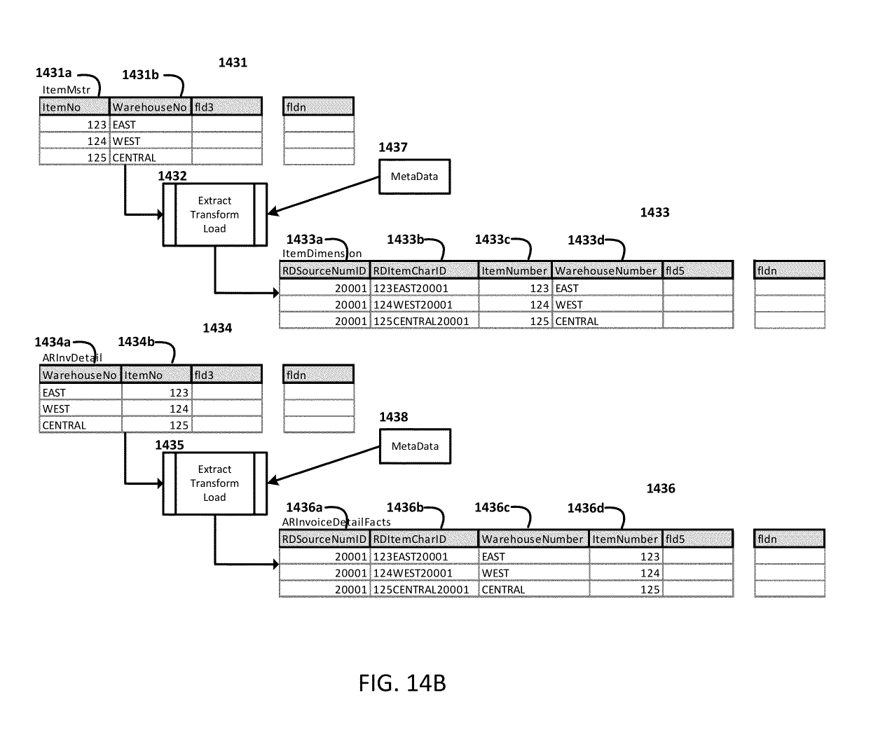

FIG. 14A is a flow diagram depicting certain steps in a derived surrogate key formation process with a combination of numeric and character natural keys. At block 1401 the system may determine a source identifier field associated with a table. At block 1402 the system may determine the multiple field, numeric and character, natural key associated with a first row of the same table. One will recognize that the first row may appear anywhere in the tables. At block 1403 the system may formulate an identifier, such as a derived surrogate key, based on the first field value and the second field value. The identifier may be formulated by combining the first and second values. At block 1404 the system may then update the identifier in the table. These operations may be performed via an ETL process configured using instructional metadata.

FIG. 14B shows the method of certain embodiments of creating Derived Surrogate Keys (DSK) for a complex numeric and character field identifier in order to create a more efficient load process for the fact tables. When building the dimension table 1433 the SAP® Data Services ETL process 1432, for example, is adapted to form a DSK field based on the source of the dimension table 1431 and the dimension's natural identifier. The DSK field will be comprised of the natural dimension identifier, in this example, ItemNumber and WarehouseNumber, and the RDSourceNumID When building the fact table 1436 the ETL process 1435 also creates DSKs based on the dimension values contained within the source transaction table 1434. The DSKs 1436b can be in the same format as those in the dimension tables, RDSourceNumID 1436a and the dimension's natural identifier, in this case the ItemNo 1456d concatenated with the WarehouseNo 1456c concatenated with RDSourceNumID 1436a.

The derived surrogate key described in the examples of FIGS. 10A-14B may help ensure consistency of the data. When updates are made to rows in the source of the dimension table a new ASK (industry standard) may be assigned to the row. When updates are made to rows in the source of the dimension table, the new rows may have the same DSK as the previous row. This may minimize the impact to system resources during Fact Table loads. It is not necessary to perform lookups to find and populate the derived surrogate key. In contrast, one must perform lookups for each loading row in the fact table to find the ASK for each of the dimensions.

Many organizations have multiple source applications, but may want all of their data in a data warehouse. The organizations may want the disparate data conformed so that they are able to report on all entities within their organization without having to write complex and resource intensive queries, which will typically involve significant IT involvement. Conforming the disparate data may be a complex process. When heterogeneous sources of data are brought together, each of the source systems will likely have different key field values for the same biographical information, as well as security issues associated with each source system.

In addition, organizations often require an ability to archive data. The effort to provide access to different source systems is a significant IT project during implementation. The effort is prolific as all data warehouse tables need to be touched. Furthermore, security issues abound when bringing separate systems together.

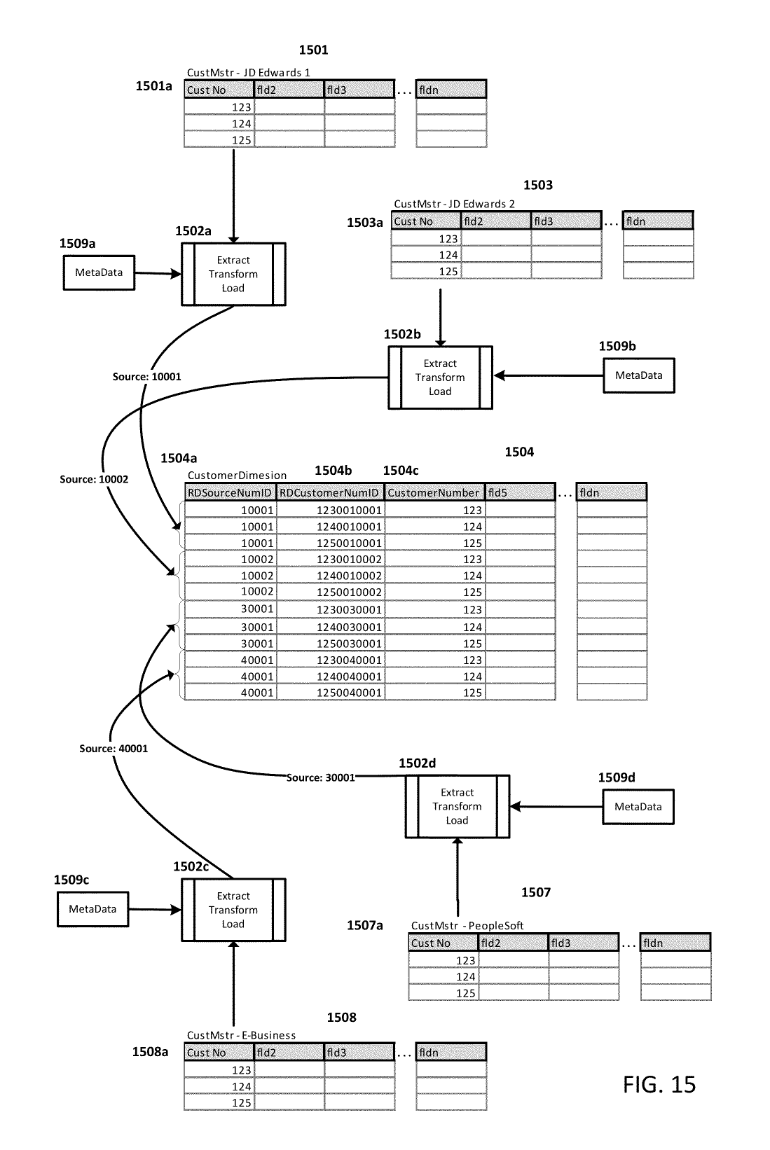

FIG. 15 illustrates a multi-tenancy feature implemented in certain embodiments to respond to certain of the above-described difficulties. The feature may require negligible field configuration. In some embodiments, the feature may be a single field within each table of the data warehouse. The data warehouse may provide a table 1504 that houses the RDSourceNumID 1504a and Description to assist in identifying where the business' data originates. This feature supports a variety of operations.

Single Source types (where there are all one ERP and version, such as JD Edwards World version A9.1), also referred to herein as homogenous, may have multiple source instances 1501, 1503 that may be housed in a single data warehouse. In contrast, Multiple Source types (where there are more than one ERP or more than one version of the same ERP we have defined as Heterogeneous), also referred to herein as heterogeneous, may have multiple source instances 1507, 1508 that all need to be housed in a single data warehouse. Archive Sources of either, Single Source, Multiple Homogenous Sources or multiple Heterogeneous Sources may need to be available in the data warehouse since they are no longer available in the source application(s).

FIG. 15 illustrates how the ETL processes 1502a, 1502b, 1502c, 1502d may move the data from the various sources into the CustomerDimension 1504. As shown in this example, the JD Edwards 1 1501 has an RDSourceNumID of 10001, the JD Edwards 2 1503 has an RDSourceNumID of 10002, the PeopleSoft source 1507 has an RDSourceNumID of 30001, while the E-Business source 1508 has an RDSourceNumID of 40001. With these embodiments a customer may have all the source data in a clean cohesive manner for consumption by business intelligence tools and other applications.

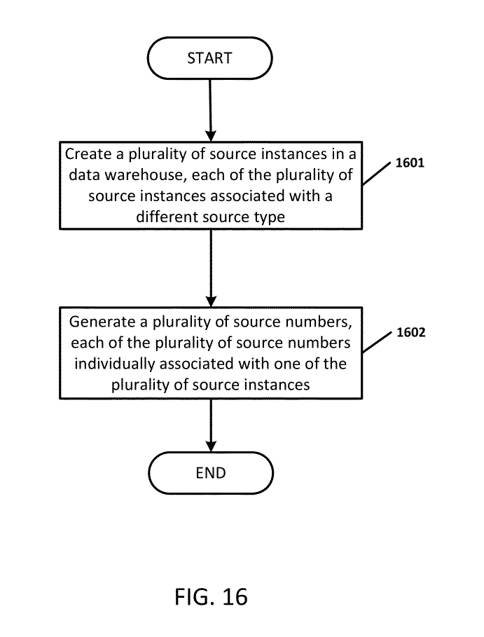

FIG. 16 is a flow diagram depicting a method for providing multisource control in certain embodiments. At block 1601 the system may create a plurality of source instances in a data warehouse, each of the plurality of source instances associated with a different source type. At block 1602 the system may generate a plurality of source numbers, each of the plurality of source numbers individually associated with one of the plurality of source instances.

In some embodiments, a customer may periodically like to use a business intelligence system to verify the validity of data. Since the BI's system source is the data warehouse, the data warehouse should provide the Auditing information. Auditing, as defined here, is the date and time of the Add of a record, the last Change date and time, and the record Deletion date and time. Additionally a special type of Delete called a Purge may be supported in certain embodiments. A Purge is a delete of many records for the primary purpose of shrinking the stored data size. Purges may be performed based on an organization's data retention requirements.

Certain embodiments integrate the Add, Change, Delete and Purge into all of the data warehouse tables in the data warehouse to the customer experience. The data warehouse may be configured to recognize the Purge user(s) or program(s) as established in the installation process. The data warehouse will mark each record as Add, Change, Delete or Purge and include the corresponding date based on the source system's related operation. Certain embodiments of the data warehouse will retain the Deletes and the Purges but mark them so they are available for reporting.

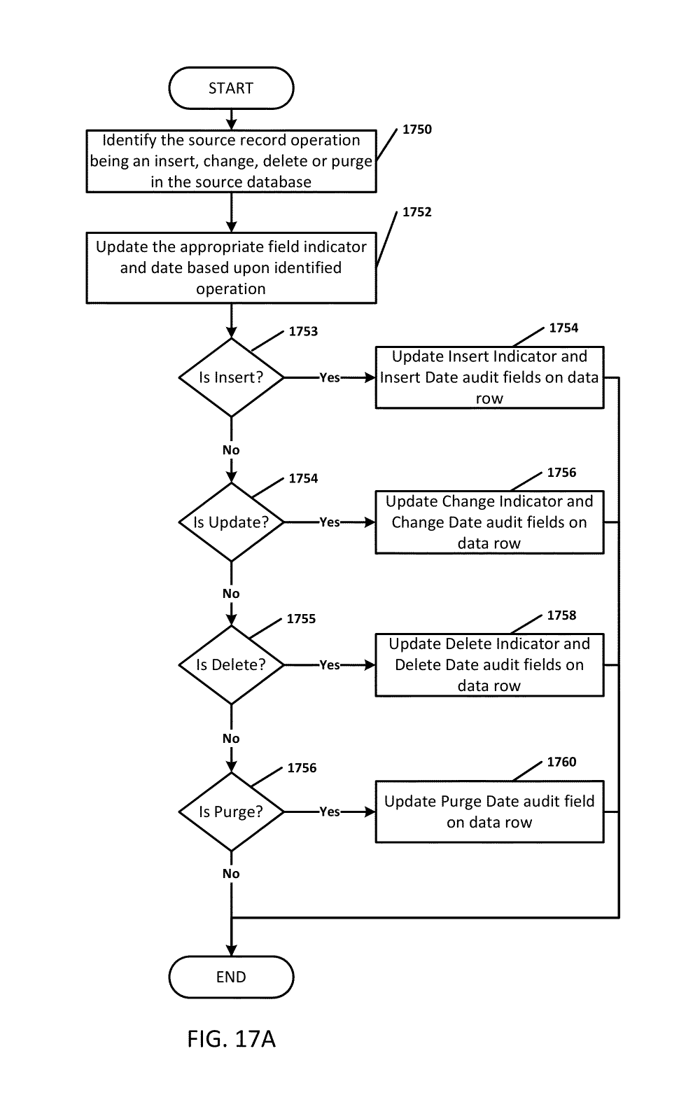

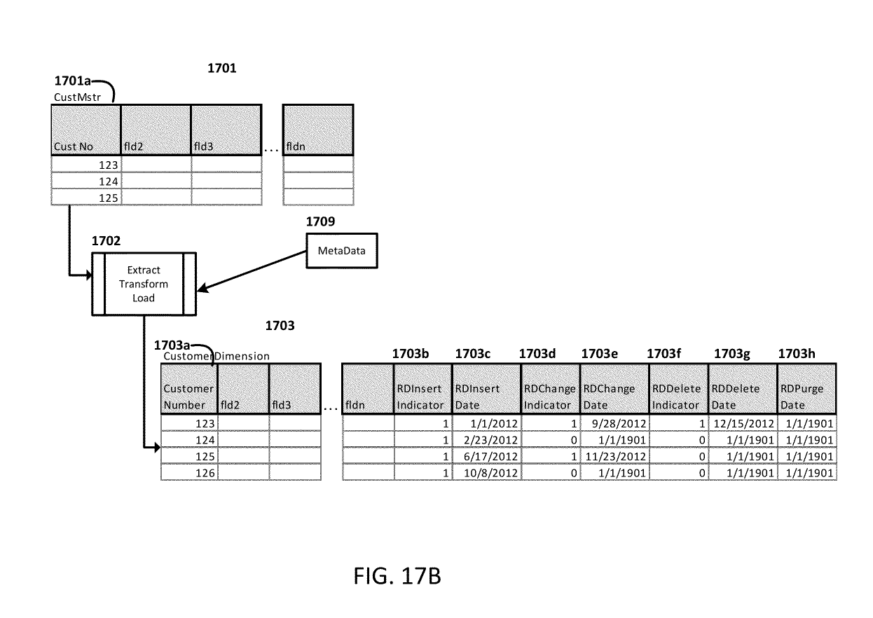

FIG. 17A is a flow diagram depicting certain steps in a method to capture modifications to the source system. At block 1750 the system may determine that a data modification operation has occurred. At block 1752 the system may update an appropriate field indicator and date based upon a certain operation. Depending upon what type of operation 1753-1756 is performed on the source system's data, updates to the appropriate Date and/or Indicator fields is performed. These assessment and update operations to the data warehouse may be performed via an ETL process configured using instructional metadata.

FIG. 17B illustrates the process of moving a source system table 1701 via an ETL process 1702 into a dimension table 1703, and shows the seven (7) fields that are included with all tables in certain embodiments of the data warehouse. Those fields are: RDInsertIndicator 1703b, RDInsertDate 1703c, RDChangeIndicator 1703d, RDChangeDate 1703e, RDDeleteIndicator 1703f, RDDeleteDate 1703g, and RDPurgeDate 1703h. In one system customers can now not only do all the BI analysis they need but can also get the auditing desired or required in some cases. These embodiments eliminate the need for a separate purchase of archival data reporting solutions. These embodiments also eliminate the need to integrate the archive data into the data warehouse in a custom effort.

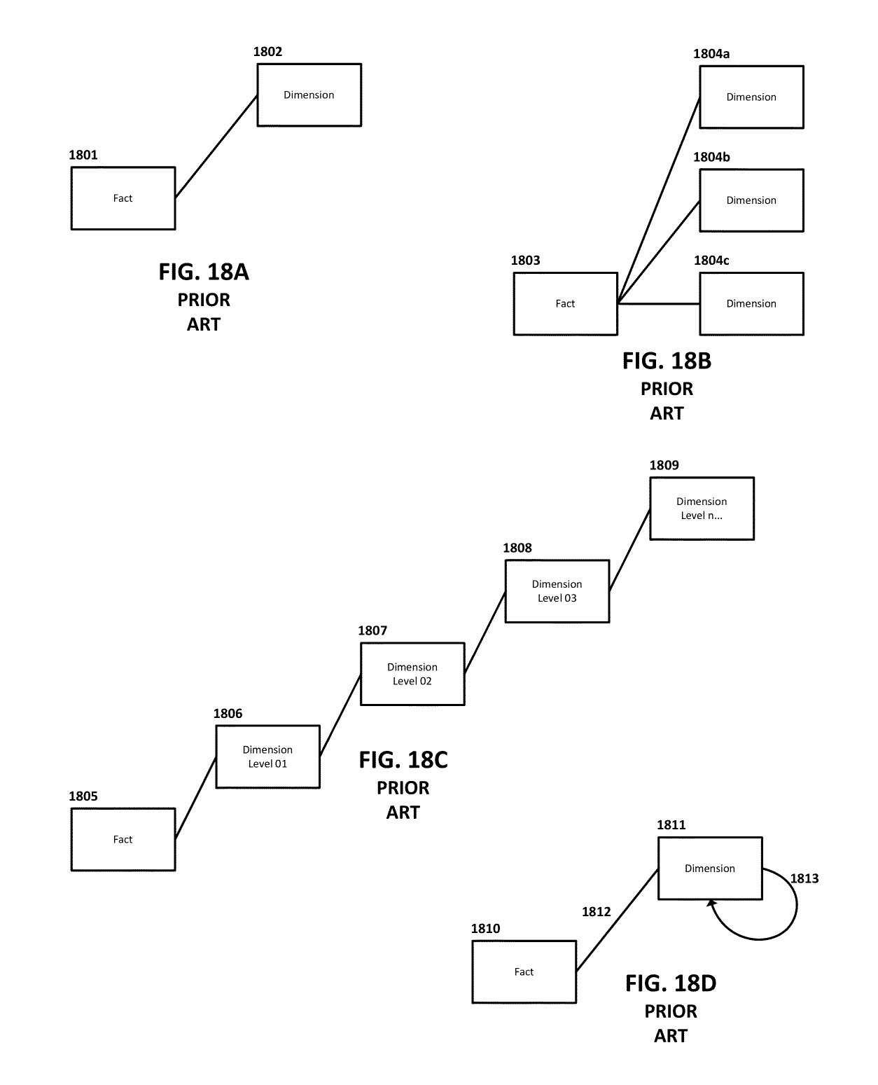

In some implementations, many subject areas have dimensions that have hard and fast or implied hierarchies. In a date hierarchy for example, any date may have a parent month that has a parent quarter that has a parent year. However, there are many times when alternate hierarchies can exist. A date can, alternatively, roll up to a week, that rolls up to a year. In this alternative case, weeks do not roll up to a month since a week can be split between months and contain dates from two months. Customers may also need to have corporate defined hierarchies such as dates that roll up to Fiscal or Financial Periods which are not months. Customers may need this flexibility to enhance their reporting capabilities. Four traditional solutions in the industry are generally illustrated in FIGS. 18A-D.

FIG. 18A illustrates how some conventional solutions build a very large, and complex, single dimension table 1802 for a hierarchy concept, like dates, that have all the required fields for all of the defined hierarchies. The issue with this is the sheer size of the dimension table. It is large to a point that it will not perform well. This industry solution is typically ever-changing as the company modifies, or defines additional, hierarchies.

FIG. 18B illustrates how some industry solutions build large dimension tables for a dimension concept like dates but creates one table per hierarchy such as one table for Calendar Monthly 1804a, one for Calendar Weekly 1804b, and one for the Fiscal Calendar 1804c. Each table has all the required fields for all the hierarchy definition of the table. The issue with this is the sheer size of the dimension table. It is large to a point that it will not perform well but better than the one above in FIG. 18A. With this implementation, the user will not be able to start drilling up or down on one hierarchy and then transfer to drilling on another hierarchy with ease. This industry solution is typically ever-changing as the company defines additional or changes existing hierarchies.

FIG. 18C illustrates how some industry solutions build large snowflakes for a dimension concept per hierarchy, for example with the dates dimension, there could be one snowflake dimension for calendar monthly 1806, one for calendar weekly 1807, and another for calendar fiscal 1808 and other levels 1809. The benefit to this is that no individual table is all that large. The problem with this is the number of joins from the fact 1805, to use the data in a report is large. As the hierarchies are changed or adjusted the tables need to be changed, deleted or others added. With this implementation, the user will not be able to start drilling up or down on one hierarchy and then transfer to drilling on another hierarchy with ease.

FIG. 18D shows the final iteration of the industry solutions is the same as in FIG. 18C, but instead of having a separate table for each level of the dimension snowflake, you have one table 1811 joined 1812 to fact 1810 and joined to itself as many times as required for the number of levels. The benefits are same as above plus the additional benefit of not needing to add or delete tables as hierarchy's changes. The problems remain the same as above but the joins to pull data out of the data warehouse to use in reporting are more complex.

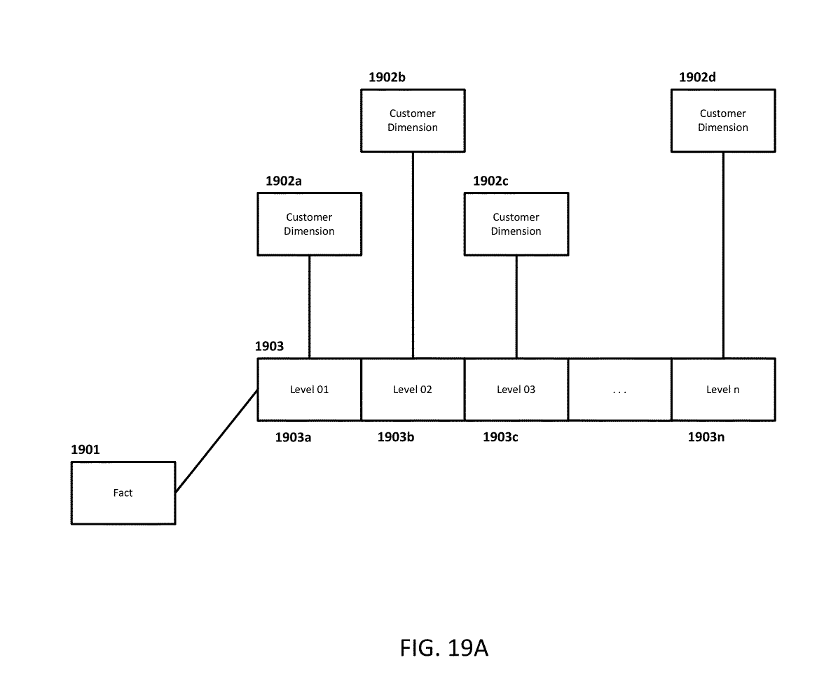

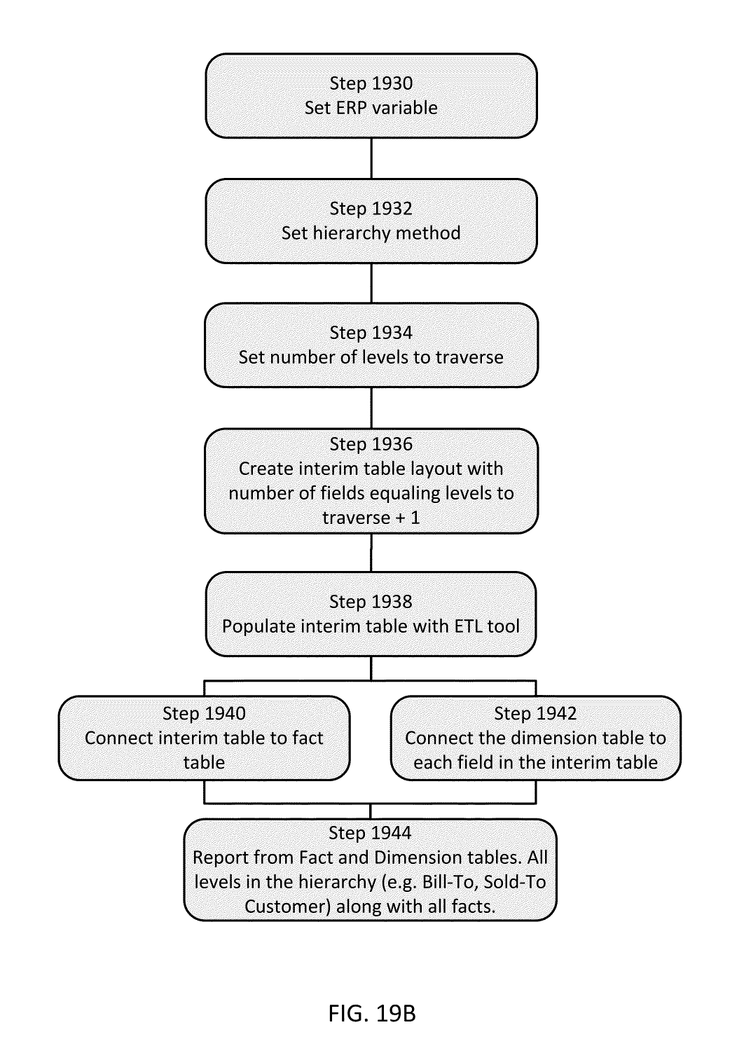

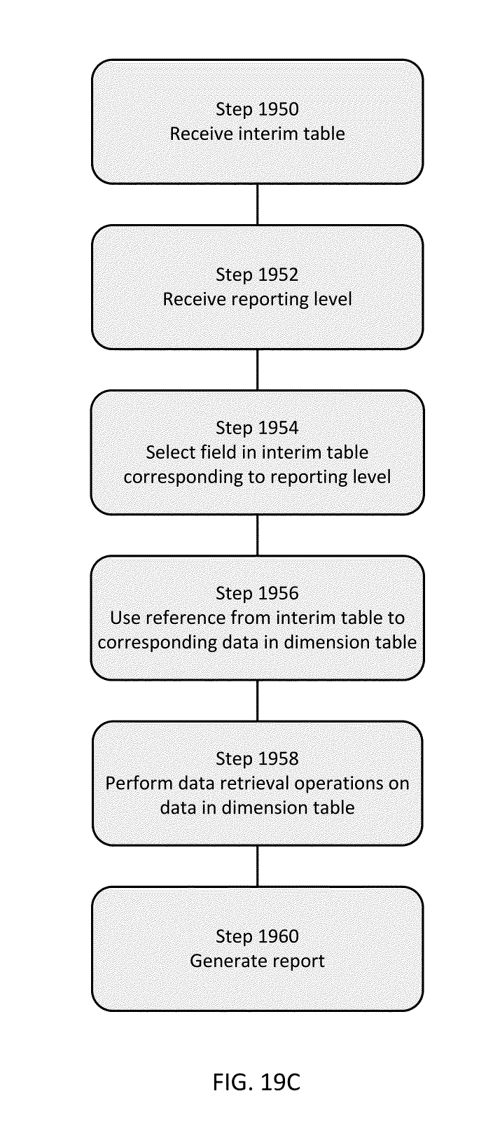

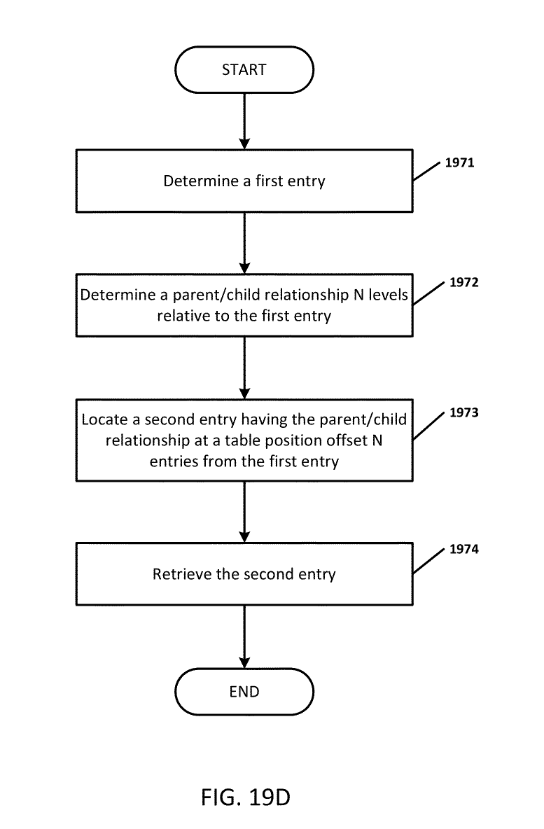

FIG. 19A illustrates a method of utilizing hierarchies in certain of the embodiments, overcoming certain of the deficiencies of the conventional structures of FIGS. 18A-D. The solution includes a table 1902a-d that has a record format containing all data required for all levels of the hierarchies. All the records are in this one table. As an example all customers, regardless of where they are in a hierarchy, be they a Bill-To, Ship-To, or Sold-To customer, for example, are stored in one table.

The embodiment of FIG. 19A may use an interim table 1903 between the fact 1901 and the dimension 1902a-1902d where the interim table that contains keys (DSKs) to the appropriate records at every level of the hierarchy. As business requirements change, and hierarchy reporting requirements change, the only table that needs to be adjusted is the interim hierarchy table. The performance impact every query has on the dimension table may be the same regardless of which level 1903a-1903n is chosen to report on, thus providing consistency of expectations. In these embodiments, the maintenance of the dimension is simpler, the ease of use in BI metadata design and reporting is improved, and drilling from one hierarchy to any other is easy and efficient, as compared to the systems of FIGS. 18A-D.

FIG. 19B is a flowchart of an exemplary method of generating an interim table, for example, the interim table shown in FIG. 19A. In step 1930, an enterprise resource planning (ERP) variable is received or set. The ERP variable may indicate a set of loading parameters associated with the type of the source table from which to load in data. Since different sources may have different loading parameters, the use of the ERP variable enables generation and use of an interim table from any type of source table. For example, in the case where the data source is a JD Edwards source, the ERP variable may be determined as follows. Firstly, it may be determined that the JD Edwards source is using an Alternate Address Book Number method (such as, 1, 2, 3, 4, or 6), and the number used is determined Secondly, the organizational structure of the JD Edwards source is determined. A JD Edwards source may use a default Parent-Child organization structure or a different (non-default) Parent-Child organization structure. The “blank” organizational structure type is the default, and anything other than the “blank” organizational structure type is the non-default. As another example, in the case where the data source is a PeopleSoft source, the ERP variable may be determined based on the PeopleSoft Trees, which are the hierarchy structures included in the PeopleSoft data source. This hierarchy structure may be defined in terms of sets and tree names. As yet another example, in the case where the data source is an Oracle® e-Business Suite (EBS) source, the ERP variable may be determined based on the EBS hierarchy tables included in the data source.

In step 1932, a hierarchy method is received or set. The hierarchy method indicates, for example, parent-child relationships embodied in the hierarchical data of the source table. In step 1934, a number of levels-to-traverse is received or set. The number of levels may be the number of levels in a hierarchy that need to be traversed in order, for example, to generate a report. The number of levels-to-traverse is used to determine the number of fields required in the interim table.

In step 1936, a layout is created for the interim table in which the number of fields of the interim table is determined based on the number of levels-to-traverse. In one exemplary embodiment, the number of fields in the interim table is set to one more than the number of levels-to-traverse. Nonetheless, other methods of determining the number of fields of the interim table are within the scope of this invention. In one embodiment, the interim table may include a set of hierarchy dimension indices with each hierarchy dimension index in the interim table corresponding to a level in the hierarchy of the dimension table. In step 1938, the interim table is populated with data from the source table using a suitable ETL tool. In one exemplary embodiment, the interim table is loaded to contain keys (DSKs) to the appropriate records at every level of the hierarchy. In step 1940, the interim table is connected to the fact table by including references to the keyed elements of the fact table. In step 1942, the interim table is connected to the dimension table by including references to the keyed elements of the dimension table. Each hierarchical level of data in the dimension table is thereby connected to data in the fact table via corresponding fields in the interim table. The fields of the interim table can thereby be used in generating reports at any desired level of hierarchy. Additionally, data can be drilled into and/or rolled up at and across any desired levels of hierarchy using the interim table 1944.

FIG. 19C is a flowchart of an exemplary method of using an interim table to generate a report. In step 1950, an interim table is received or generated as shown in FIG. 19B. In step 1952, a reporting level in the data hierarchy is received or selected. In step 1954, exemplary embodiments determine a field in the interim table that corresponds to the selected reporting level. In step 1956, exemplary embodiments use the connections between the interim table and the dimension table to refer to data in the dimension table that correspond to the selected interim table field and thereby the selected reporting level. In step 1958, exemplary embodiments perform data retrieval operations on data at the selected reporting level, for example, by retrieving the data, rolling up in the hierarchy, drilling down into a hierarchy, and the like. In step 1960, the retrieved data may be processed to generate a report.

By making use of the references in the interim table to the fact and dimension tables, exemplary embodiments significantly improve the speed and efficiency with which hierarchical data may be accessed at any desired level. The use of the interim table enables a user to start drilling up or down on one hierarchy and then transfer to drilling through another level with ease and at high speed. A rolling format can be used or altered by, for example, resetting the offset distance to identify which level in an interim table is used to retrieve the appropriate data. Additionally, the interim table may be altered to provide for a change in reporting without needing to change the dimension.

FIG. 19D is a flow diagram depicting certain steps in a process for traversing a hierarchical table such as the Table of FIG. 19A. At block 1971 the system may identify a first entry in a table, and at block 1972 may determine a parent/child relationship for the first entry. For example, the entry may be a “city” value and the system may be searching for a corresponding “state” or “nation” value. At block 1973 the system may locate a first entry having the parent/child relation at a corresponding offset distance. For example, the “state” may be one level in the hierarchy relative to the “city” and the second entry corresponding to the “state” will be located one index away. A “nation” value can be two levels higher and may accordingly be offset two indices from the “city” entry. In this manner, the system may use the location of the entries in the table to infer the hierarchical relation and to quickly access and retrieve 1974 data based thereon. Thus, an offset distance is used to select the proper level for search of the dimensions.

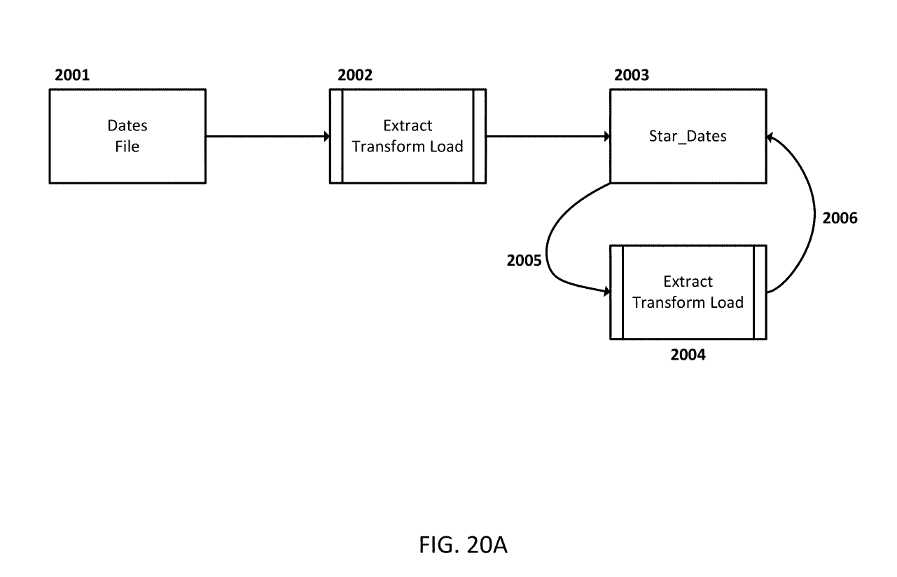

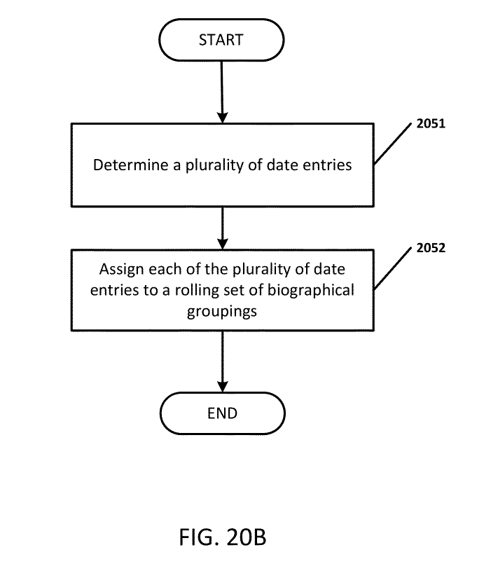

FIG. 20A illustrates a method used in certain embodiments to build a dates dimension. This includes an ETL 2002 step to load dates into a file 2003, a second ETL process 2004 can be used to extract 2005, transform and load 2006 into the same file. This method allows for many different date hierarchies as well as unique information previously unavailable to Business Intelligence systems.

FIG. 20B is a flow diagram depicting a method used in certain embodiments to create a dates dimension. At block 2051 the system may determine a plurality of date entries. These date entries may have been previously created by a user of a source application. The date entries may be in a format depicting the entirety of the date information, e.g., MM-DD-YYYY. At block 2052 the system may assign each of the plurality of date entries to a rolling set of biographical groupings. The biographical groupings may be organized in a hierarchy and stored in a single table, e.g., table 1803 as depicted in FIG. 18B. In some embodiments, the system may assign the date entries to the rolling set of biographical groupings at the end of an operational day.

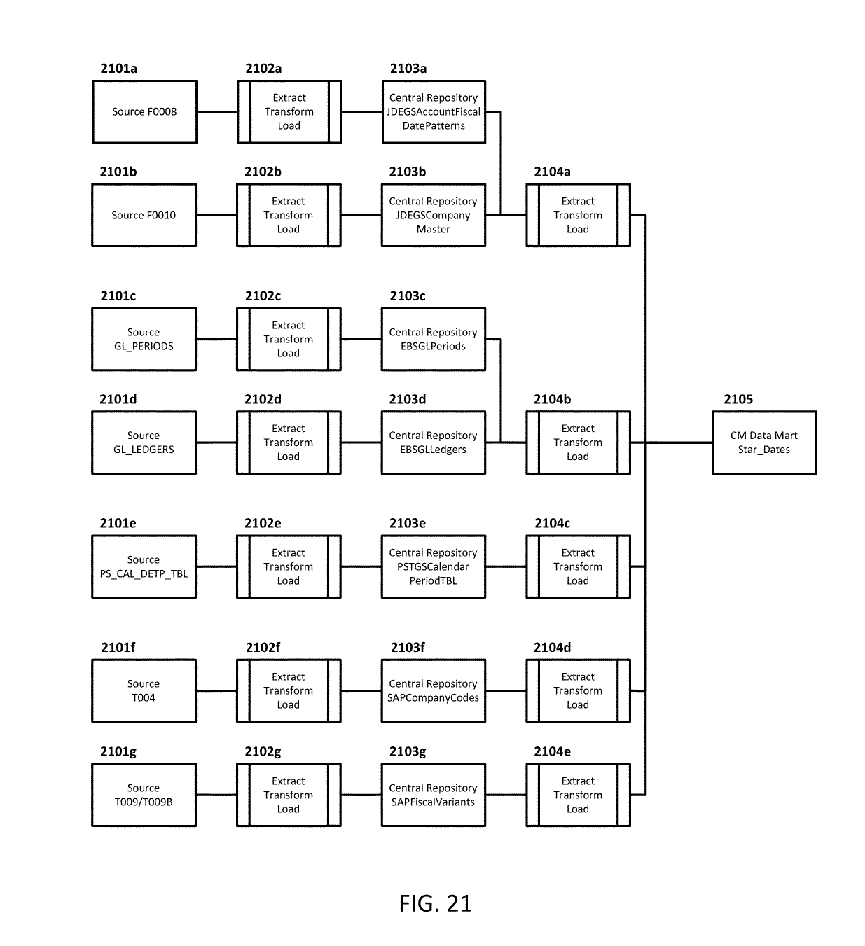

FIG. 21 illustrates how certain embodiments move data from the separate source ERP calendar and company information data stores 2101a-2101g into the Common Data Mart's STAR_DATES dimension 2105 using load 2102a-2102g, storage 2103a-2103g, and load 2104a-2104e steps.

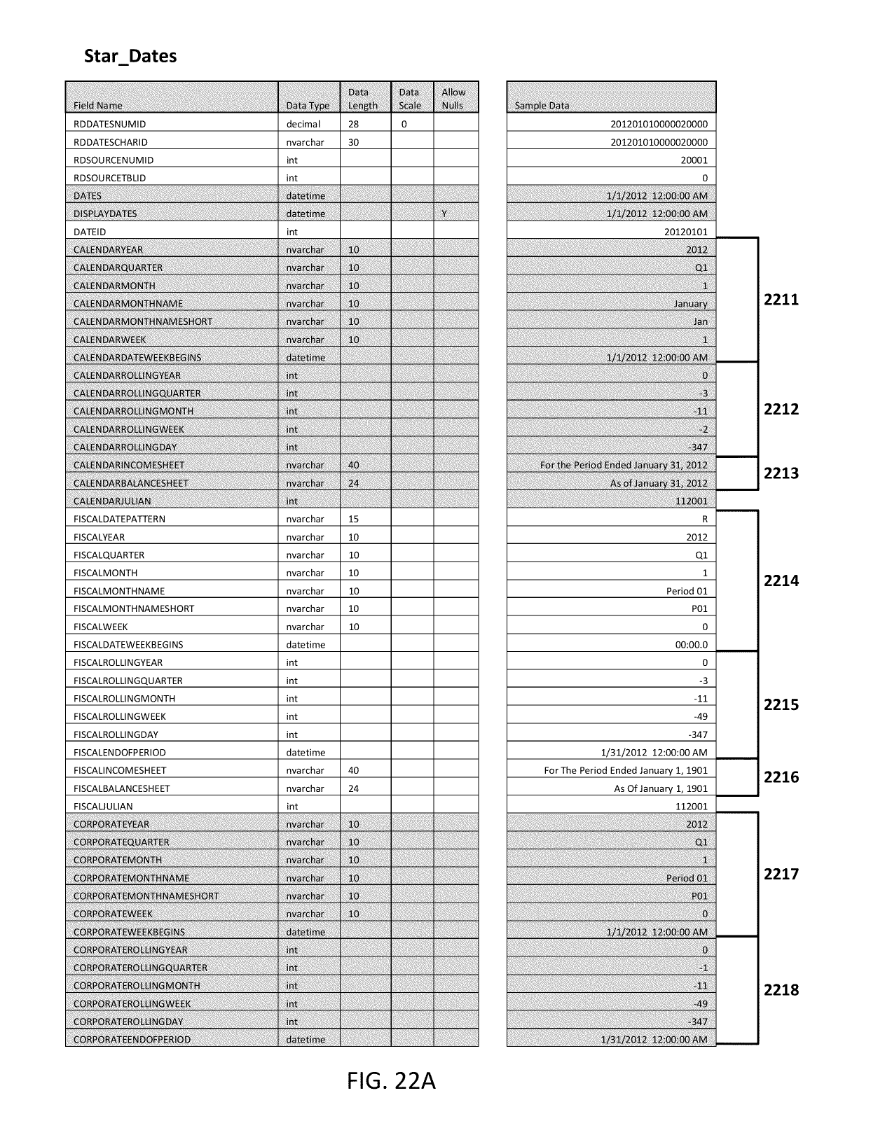

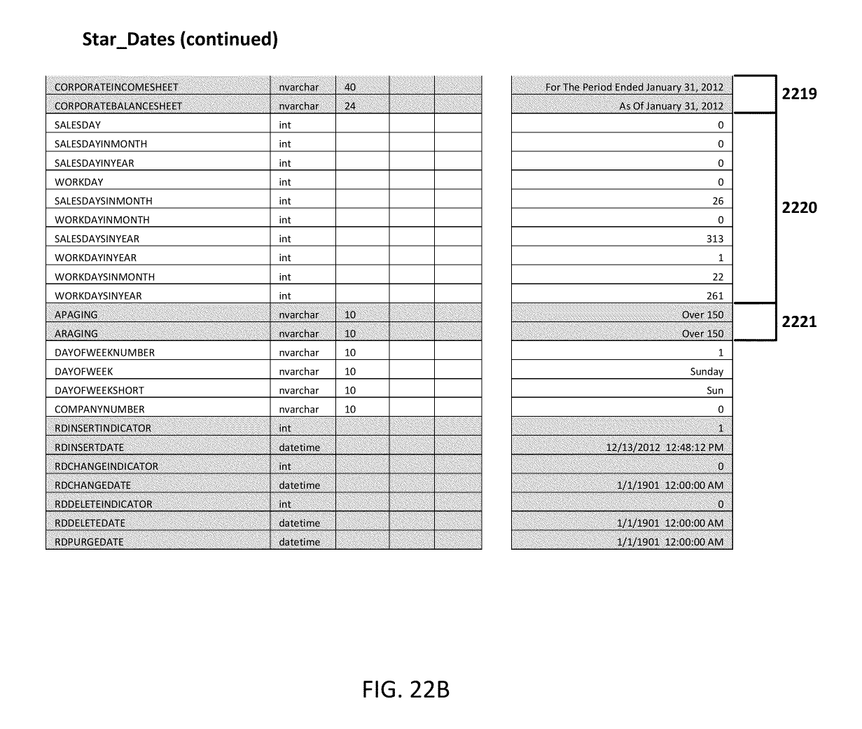

FIGS. 22A-B illustrates how the structure provides many unique value propositions in the dates dimension. Biographical information regarding Calendar Information 2211, Fiscal Information 2214, and a “Roll Up” to Corporate Fiscal Information 2217 is vast. Rolling information is included at entries 2212, 2215, 2218. Over time, rolling periods may become a valuable tool for measuring data. In a rolling solution, each night the dates are assigned to a rolling set of biographical groupings.

Certain embodiments adjust the dates dimension which is significantly smaller and is related to the data. Certain embodiments have separate sets of rolling biographical information for: Calendar 2212, Fiscal 2215, and Corporate Fiscal 2218. These embodiments may provide a way for the end user community to no longer need to do the complex formatting required for Financial Reporting titles 2213, 2216, 2219. The process may either not exist, be hard-coded, or be limited in nature. Certain embodiments provide the Financial Reporting titles as fields to simply display on any report. The Financial Reporting Titles definitions may be created using key information inherited from the source system through an ETL process as described herein.

These embodiments provide ways for customers to easily, quickly, and reliably perform Accounts Payable and Accounts Receivable aging 2221, for example. These embodiments mitigate the need for an automated process to run over the vast amount of fact data to summarize and put into aging buckets each measure required by the end user community. This automated process may be volatile, invasive and very time consuming.

By contrast, by using the above-described dates dimension that may be updated once per day, a user can see the real time fact data in the aging buckets as defined in the source application. The aging buckets definition and ranges are inherited through the ETL process and used to calculate the aging buckets. The end user reporting community experience, and flexibility in using the data, is greatly improved. The ability to do Accounts Payable and Accounts Receivable aging on real-time data provides considerable benefit.

In the JD Edwards ERP system's General Ledger module, for example, the Account Master information is used to build an Account Dimension. Unfortunately, the Account Master table is one in which each record in the table (Child) is related to another record (The Parent) in the table. The only exception to this is the ultimate parent. This table however, does not carry on the record of the key field to the parent record. The parent is defined algorithmically as the record within the same business unit, with a lower magnitude value and a lower level of detail.

Many industry solutions, including custom solutions, build hundreds of lines of custom code to rebuild this hierarchical dimension. This operation may only be done on a rebuild/refresh basis. In contrast, present embodiments contemplate a way to resolve this issue utilizing a transform of Parent/Child and Hierarchy/Flattening in a unique manner, and building the logic to do the hierarchy maintenance in a continuously fed manner by a business unit. For example, SAP® Data Services (DS) Transforms may be used.

Thus, in preferred embodiments, derived surrogate keys are generated and retained to identify parent records with hierarchy maintenance. Consequently, the customer's business end user can see the latest hierarchy without requiring a lengthy, volatile and invasive process.

Generally, customers want 100% reliable data. Customers want the solution to be the minimum definable impact to their production systems, their network, their data warehouse, and their BI systems. They want their data to be available in their BI systems in near real time. They want multiple tenants to be housed in the data warehouse.

Many industry approaches to data warehousing use refresh based processing. In a refresh, users may be logged out of the BI system and all or part of the data warehouse may be cleared. Large queries may be run on production system tables and all the data may be moved across the network. The data may be loaded to the data warehouse and mass calculations performed. Users may then be allowed back into the BI system. 100% of this data may be moved to try and synchronize the production system and the data warehouse even though a small fraction (<1%) of the data has typically changed. In some instances, 100% reliable data is not a possibility unless you can also quiesce the production system. Generally, this is not a reasonable assumption. As such, the data warehouse will always have out of sync anomalies. Generally a refresh is not the real-time solution a customer desires. Many data warehouses are designed for single tenants and avoid the customizations which must be designed, implemented and tested to achieve multi-tenancy.

Certain embodiments include instantiating and establishing (publishing) a monitoring of the source database logs that capture every Add, Change and Delete of records. These embodiments may use logs as they are the only known method for identifying 100% of a database record's, adds, changes, and deletes. Certain embodiments use SAP® Data Services as the ETL mechanism to move data. SAP® Data Services is capable of refresh and is capable of reading the Published log. Certain embodiments of the data warehouse may perform an initial load of the product using SAP® Data Services to do the refresh by programming SAP® Data Services with appropriate metadata. SAP® Data Services processes the log of data changes after the refresh so as to establish a “Full Synchronization” of the production system and the data warehouse. Certain embodiments create SAP® Data Services metadata in the form of projects that have jobs to now control the Change Data Capture (near Real Time) movement of data. In some embodiments, the solution moves only the adds, changes, and deletes, as they occur. This advantageously achieves a more minimal definable impact to the source, network, data warehouse, and BI systems.

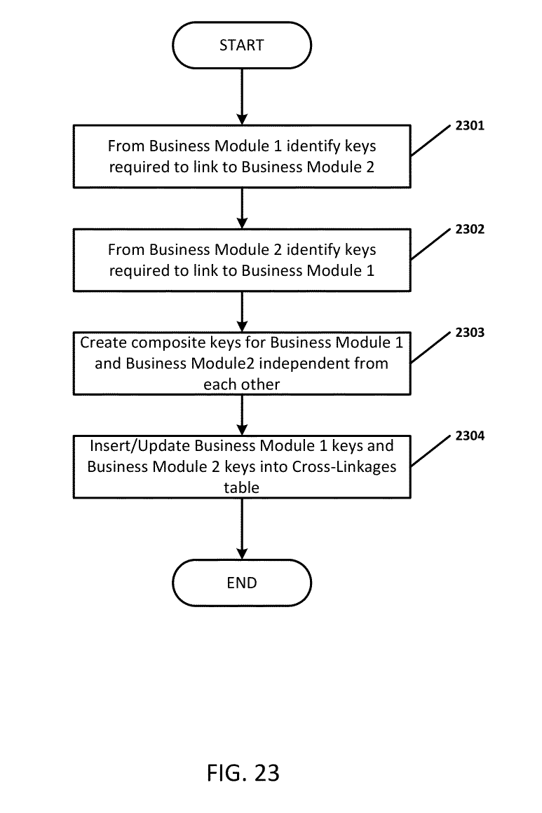

FIG. 23 is a flow diagram depicting a method used in certain embodiments to provide cross-module linkages. At block 2301, when generating the composite keys for business module 1 and business module 2, independent from each other, fact table 1 is used to generate the fact table 1 to fact table 2 cross-module linkages. At block 2302, a series of rows are generated, in certain business situations, from fact table 2 to fact table 1. This creates a different set of linkages. When formulating xlink field 1, and xlink field 2, no two ERP systems have the exact same keys. The embodiments disclosed here, generate a derived composite key, previously described, and relied upon. The derived composite keys are built to support all data sources. At block 2303, the composite key for xlink 1 and xlink 2 is generated. In this manner a business user is able to traverse from Fact table 1 through to Fact Table 2 transactions and find the related transactions associated with the Fact Table 1 transaction in question. Additionally, by generating the xlinkages in both directions a user can also traverse from Fact Table 2 through to Fact Table 1, at block 2304. The results would be different and appropriate based upon the business needs.

An example business need would be to use Sales Orders and Accounts Receivable Invoices. The requirement would be to traverse from one single line item of one sales order through to the multiple periodic invoices over time related to that one single line item on the sales order. Conversely, a user in Accounts Receivable, may want to traverse from a single invoice through to the multiple sales orders billed on that one invoice. Both business needs can been met with this embodiment.

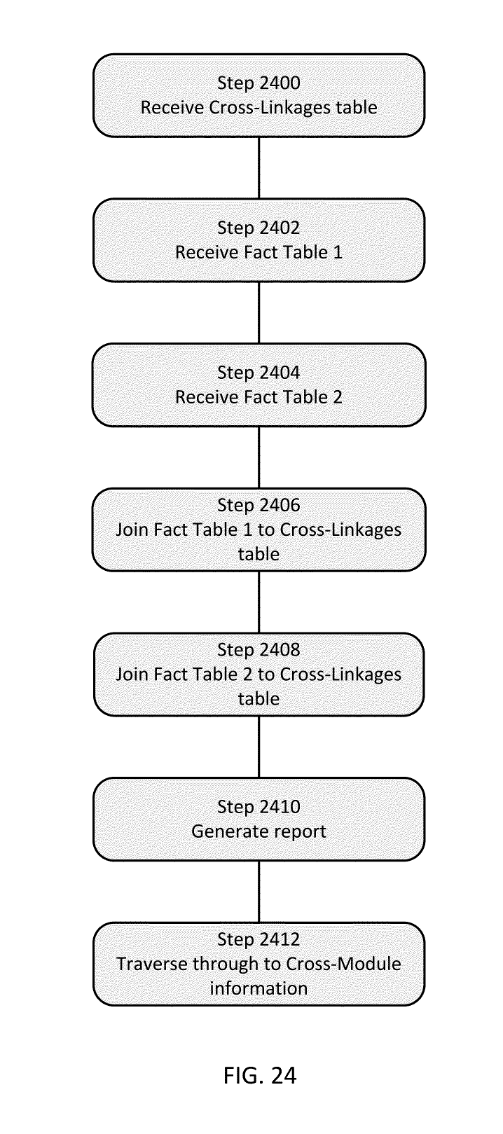

FIG. 24 is a flowchart of an exemplary method of using a Cross-Module linkages table to create a report that allows a business user to easily traverse from one business module to another. In step 2400, a Cross-Linkages table is received or generated as shown in FIG. 23. In step 2402, a module's Fact table is received or selected. In step 2404, another related module's Fact table is received or selected. In step 2406, exemplary embodiments determine a field in the Cross-Module Linkages table that corresponds to the first module's data field. In step 2408, exemplary embodiments use the connections between the Cross-Module table and the second fact table to refer to data in the fact table that correspond to the selected cross-module data field. In step 2410, the retrieved data may be processed to generate a report. From within the generated report a business user is then able to traverse through to the related module's information.

By making use of the references in the cross-module table to the fact and dimension tables, exemplary embodiments significantly improve the ability for business users to traverse from one business module to another. The use of the cross-module table enables a user to start traversing from one module to another without having to create very complicated reports.

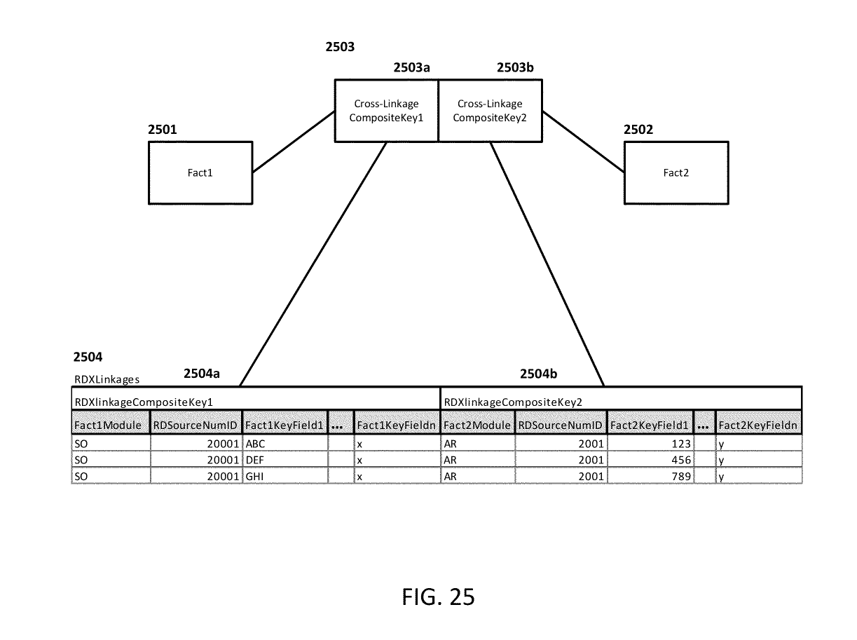

FIG. 25 illustrates a method used in certain embodiments to provide cross-module linkages as illustrated in FIG. 23. Fact table 2501 and fact table 2502 are used to generate the cross-linkage composite key 2503. The respective composite keys 2503a and 2503b are used to generate a linkage table 2504 to create linkages in both directions between fact table 2501 and fact table 2502.

The following figures and description further illustrate certain differences between data sources and how the methods and systems disclosed herein support different data sources.

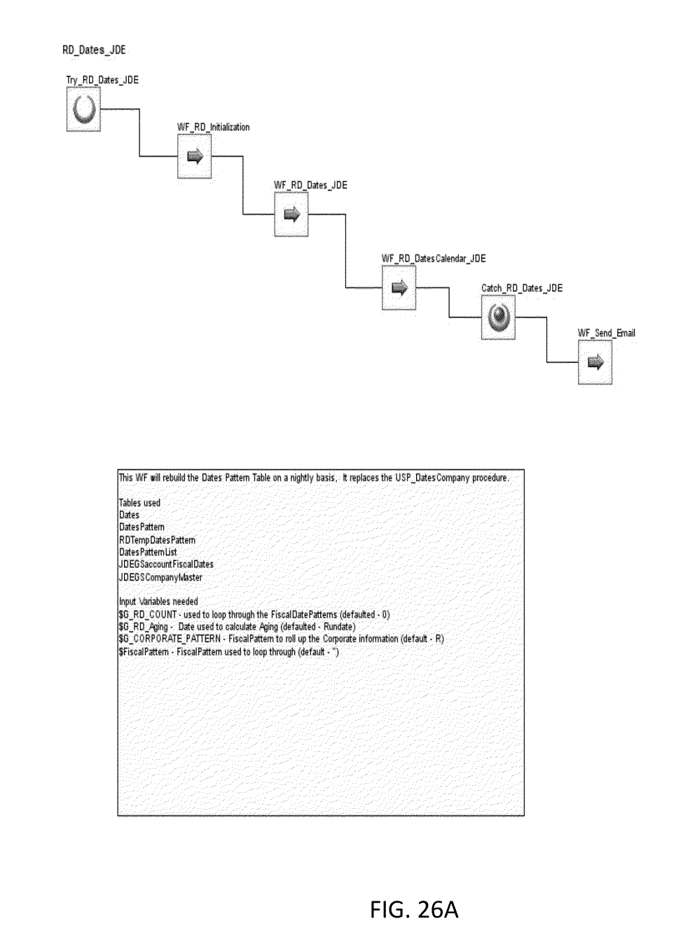

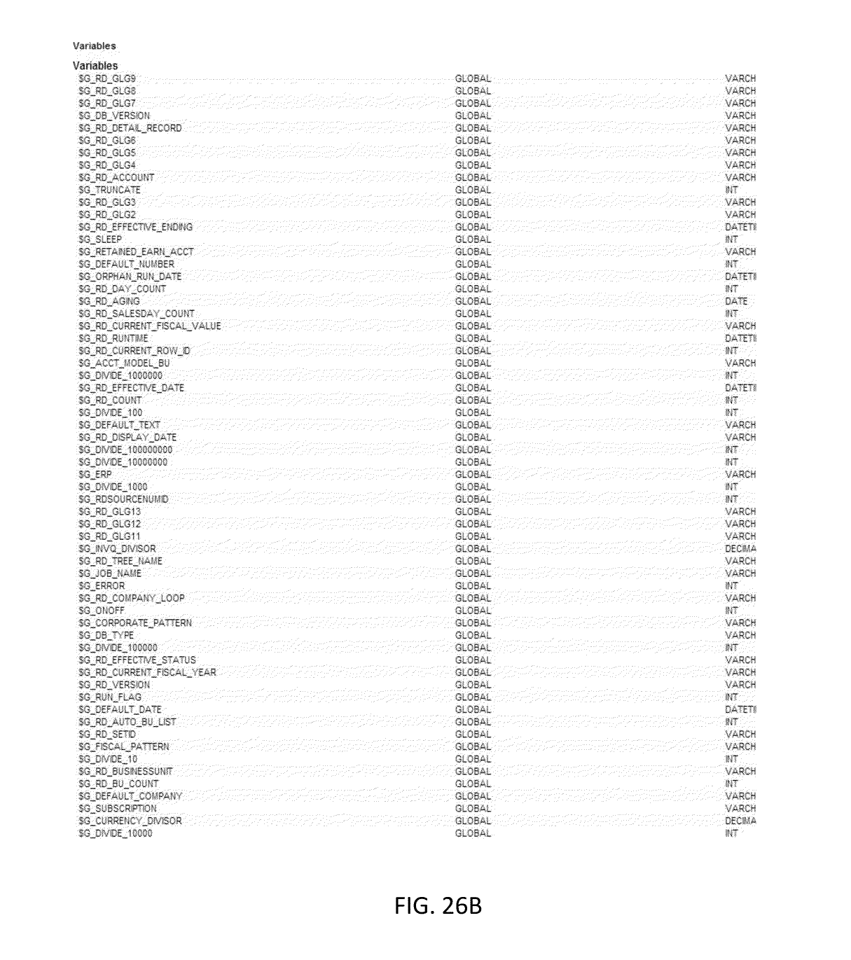

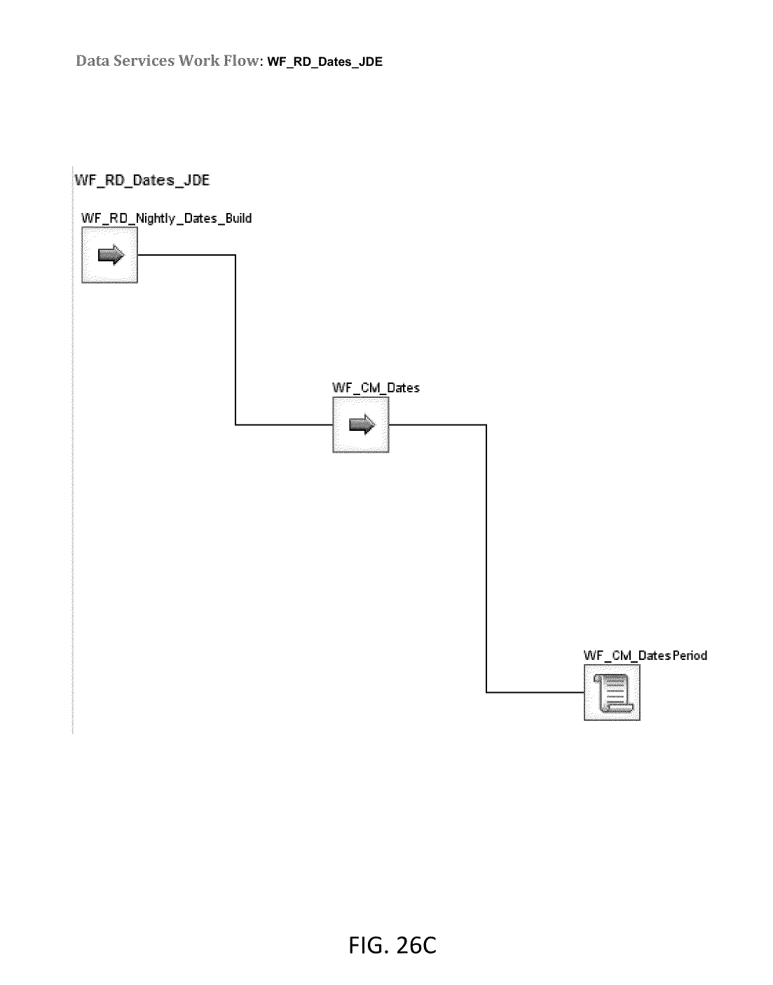

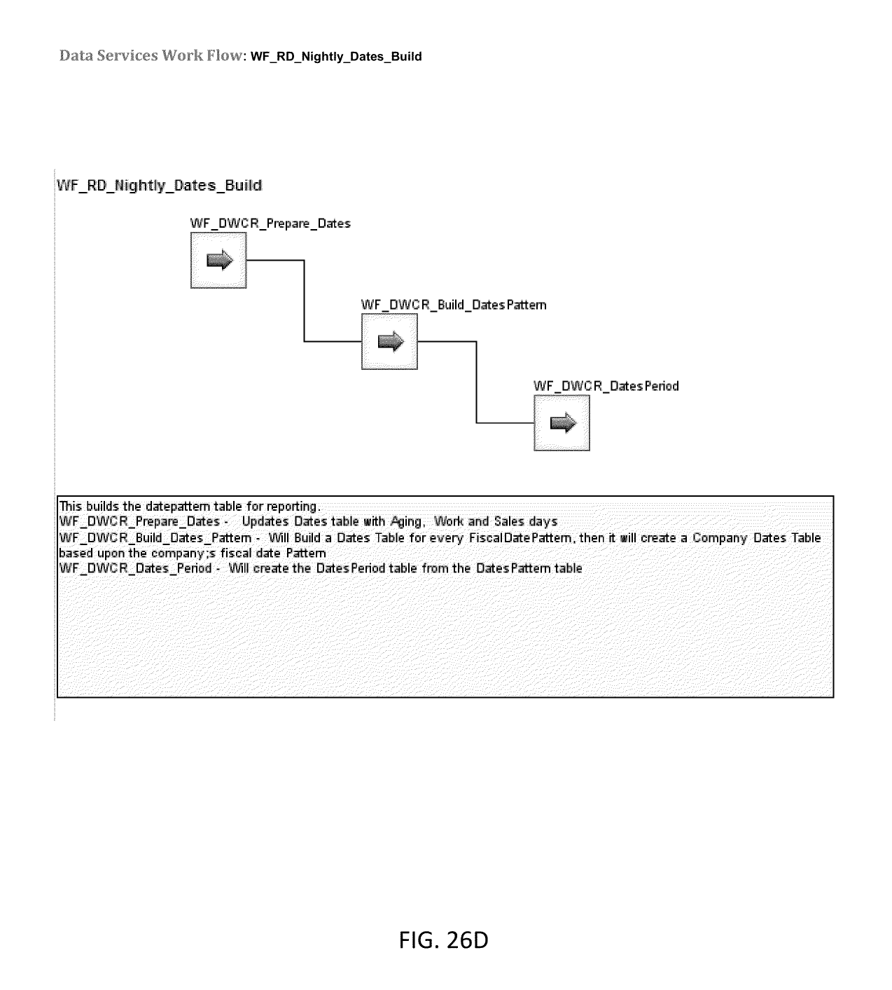

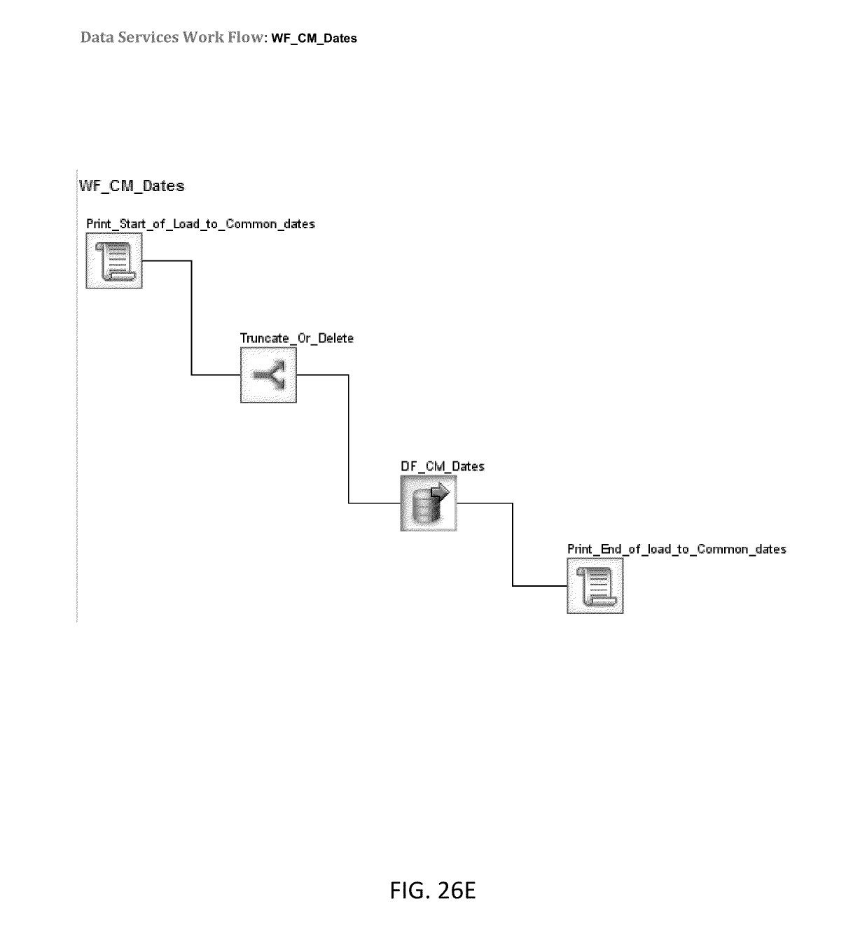

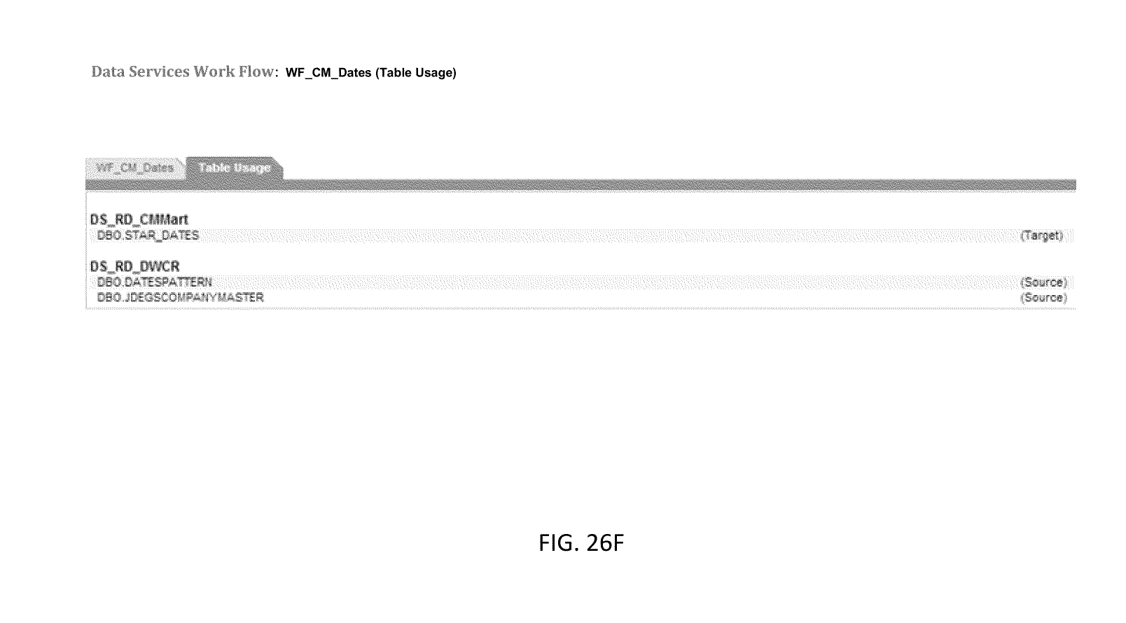

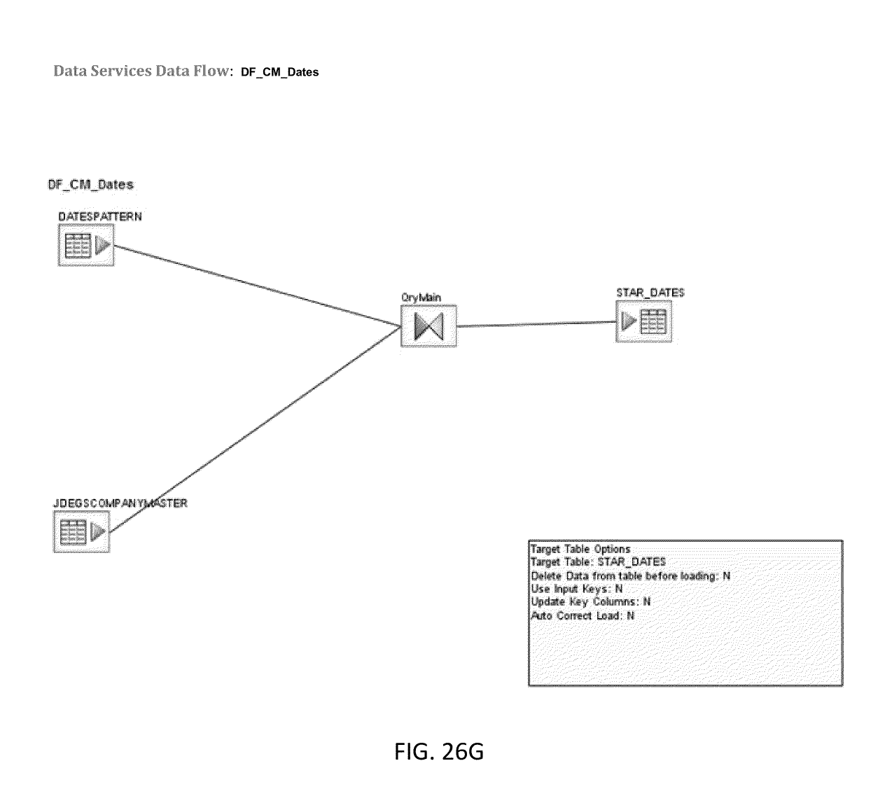

FIGS. 26A-G illustrate flow diagrams for an ETL tool, for example a JD Edwards source. In this example, the ETL tool is SAP® Data Services. In general, the jobs, variables, workflows and data flows can vary based on the type of data source. FIG. 26A shows a workflow that rebuilds the dates pattern table on a periodic (nightly) basis using tables from the JD Edwards data source, such as JDEGSAccountFiscalDates and JDEGSCompany Master. FIG. 26B shows the variables used in the workflow of FIG. 26A. Thus, the dates pattern for each source can have a distinct plurality of variables. FIG. 26C shows a workflow for a daily dates build based upon a particular user entity's corporate master date information. FIG. 26D shows a workflow that builds the dates pattern table for reporting, by updating the dates table with aging, rolling, work, and sales days. FIG. 26E shows a workflow that can include truncation or deletion operations, for example. FIG. 26F shows the tables assembled and displayed to a user on screen. FIG. 26G shows a dataflow using the tables of FIG. 26F to build a STAR_DATES table.

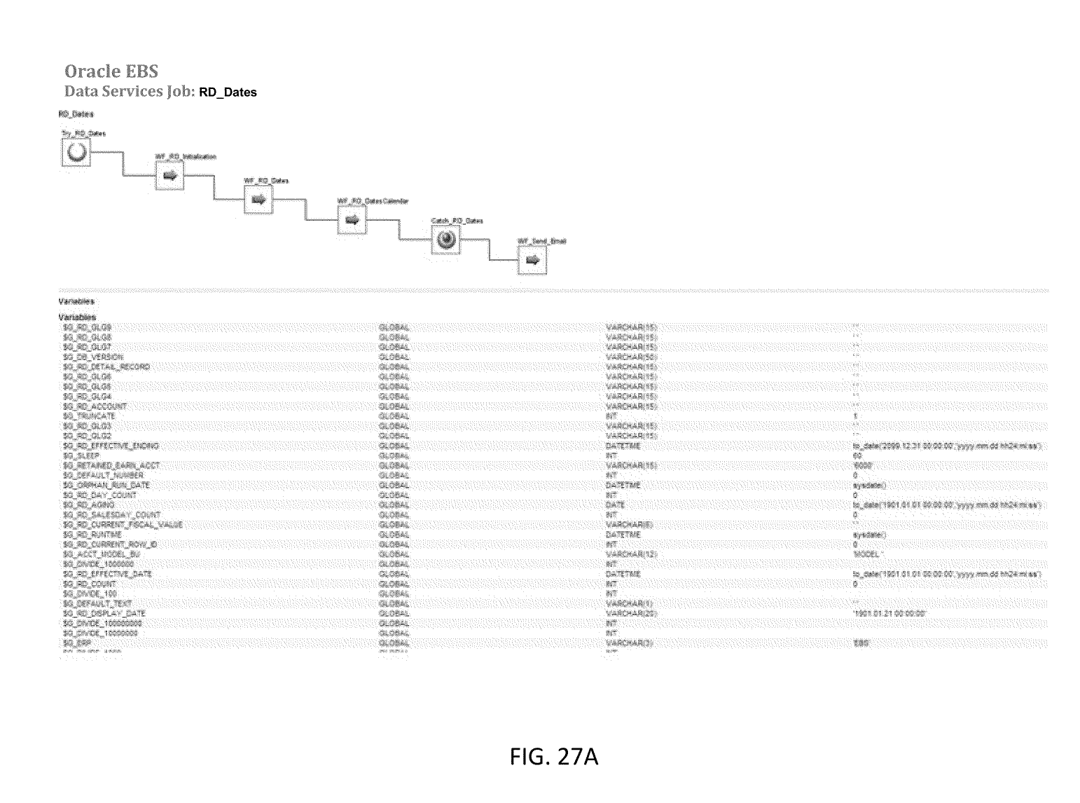

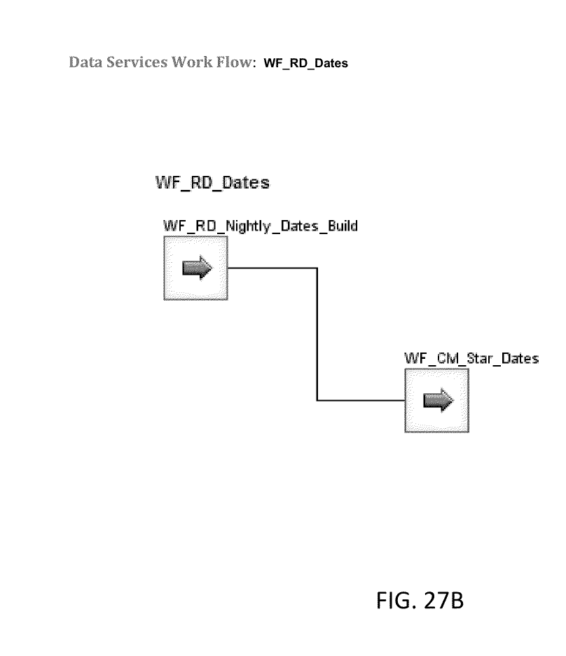

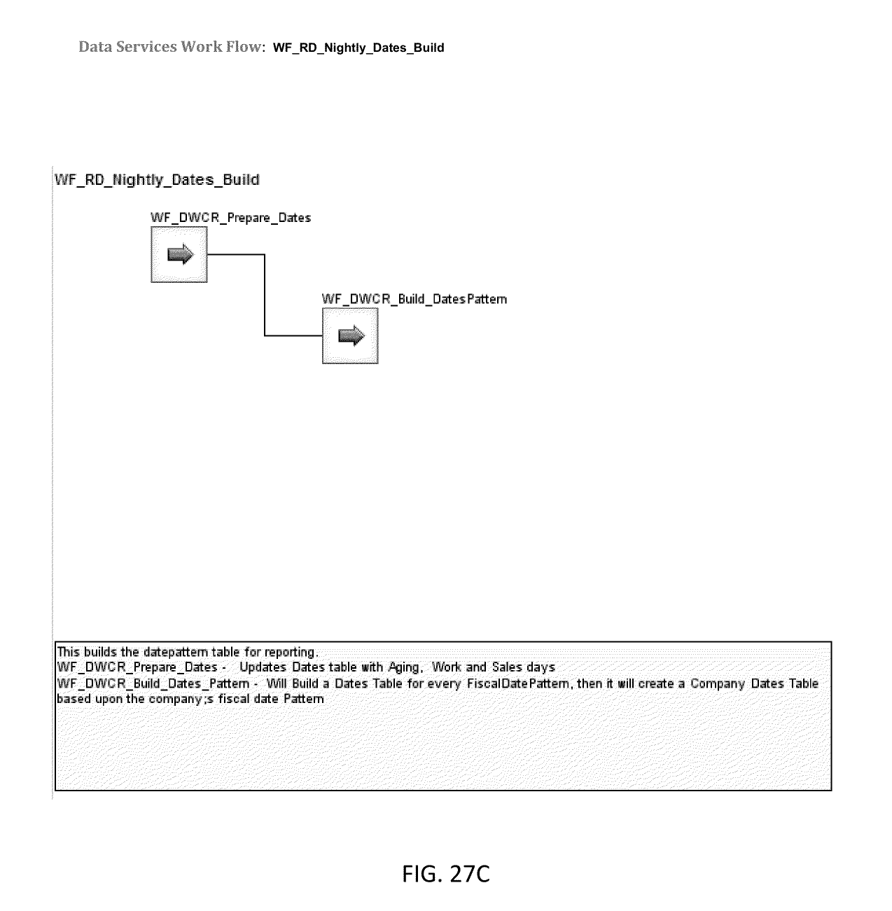

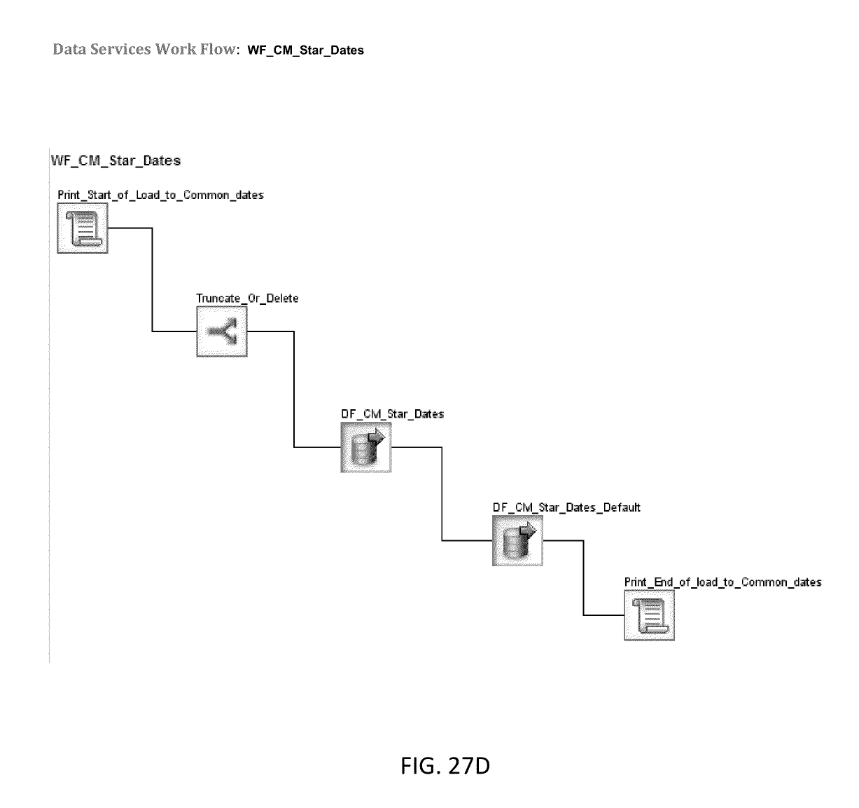

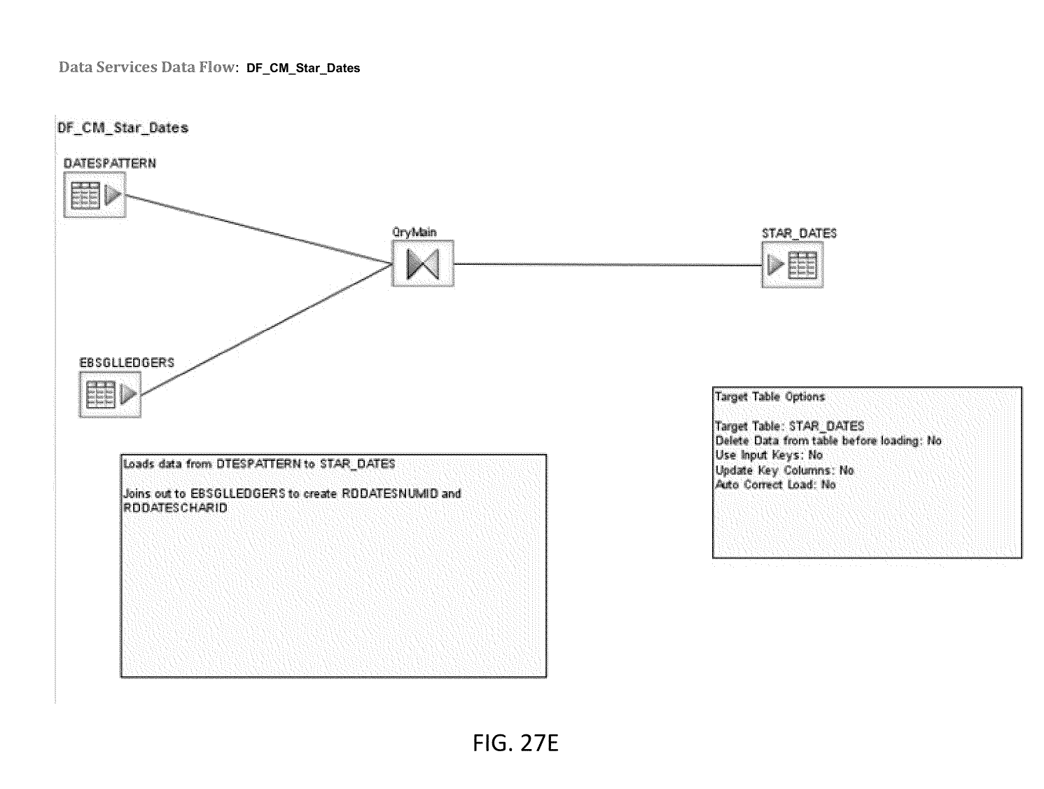

FIGS. 27A-E illustrate flow diagrams for an ETL tool, for example, an E-Business Suite (EBS) data source. FIG. 27A shows a workflow that rebuilds the dates pattern table on a periodic or daily basis using tables from the EBS source and the variables shown in FIG. 27A. FIG. 27B shows a workflow for periodic (daily) build of a STAR_DATES table. FIG. 27C shows a workflow that builds the dates pattern table for reporting, by updating the dates table with aging, rolling, work, and sales day. FIG. 27D shows a workflow for operations for daily build. FIG. 27E shows a final dataflow for assembly of a STAR_DATES table based on the EBS source that can be targeted for report building.

Thus, the flow diagrams illustrated herein exemplify the different ETL parameters that can be used in loading data from different sources. Different sources can have different types of data, different fields to organize the same data, and/or different relationships in the dataflows used to organize the data to meet the different reporting requirements specified by different groups within an organization. A business intelligence software tool can have a plurality of different report formats that reflect the different sources that are delivered periodically into a warehouse or different datamarts for a specific organization. The system is highly automated and dynamic as it is able to allocate computing resources as needed to manage multiple data sources providing data daily or continuously.

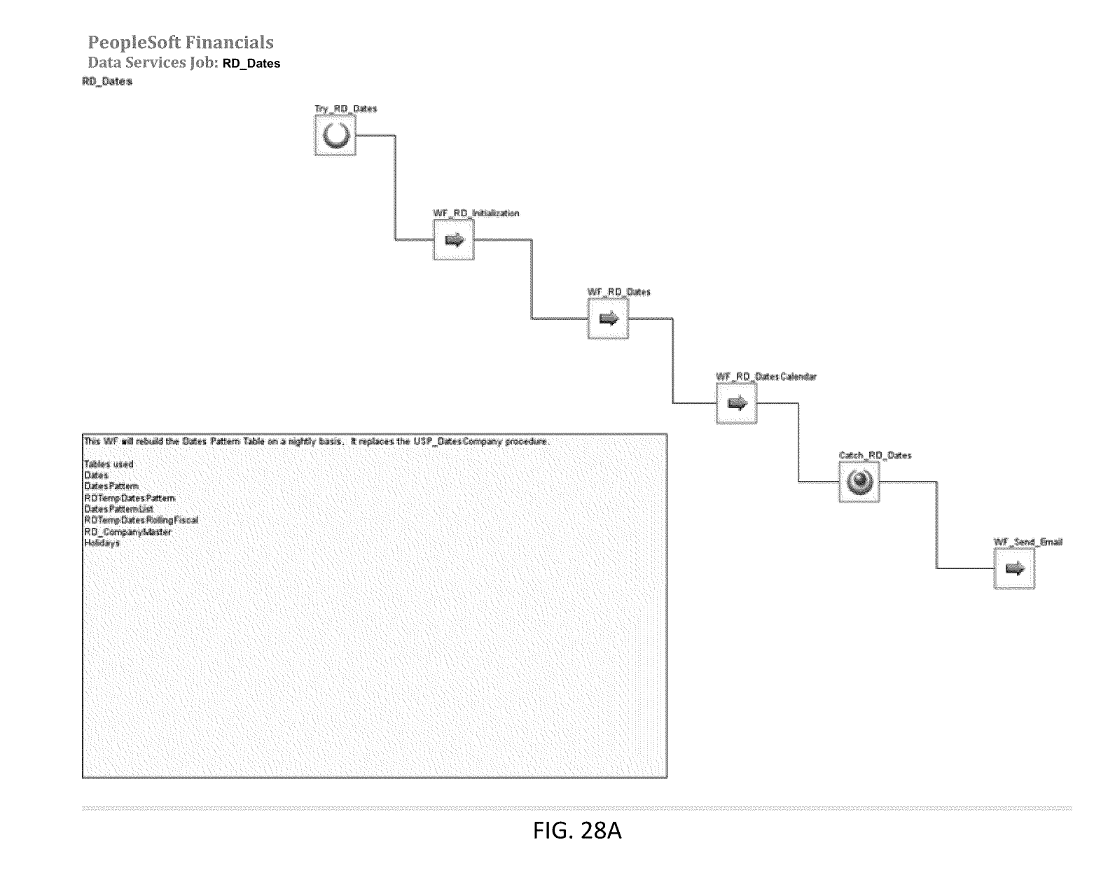

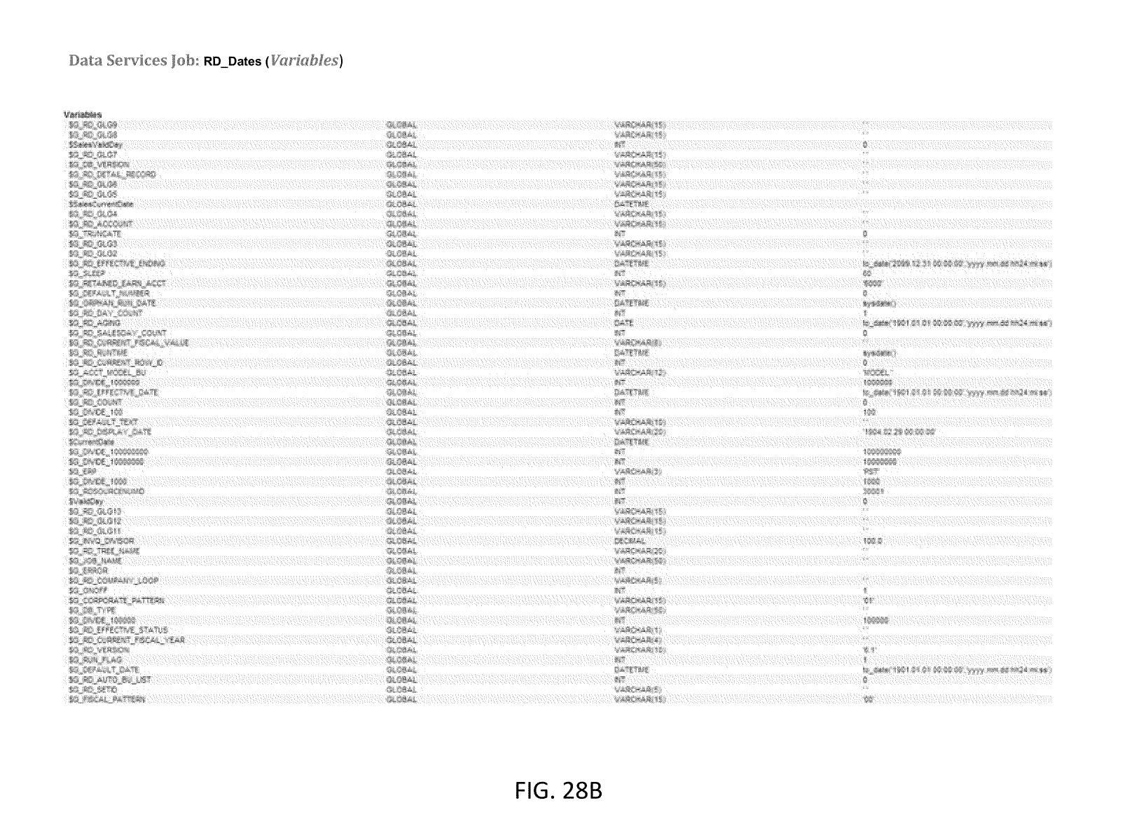

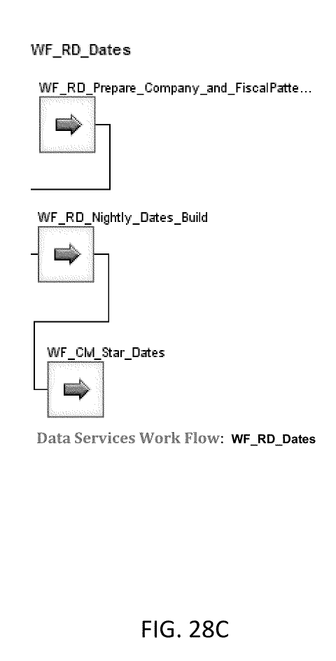

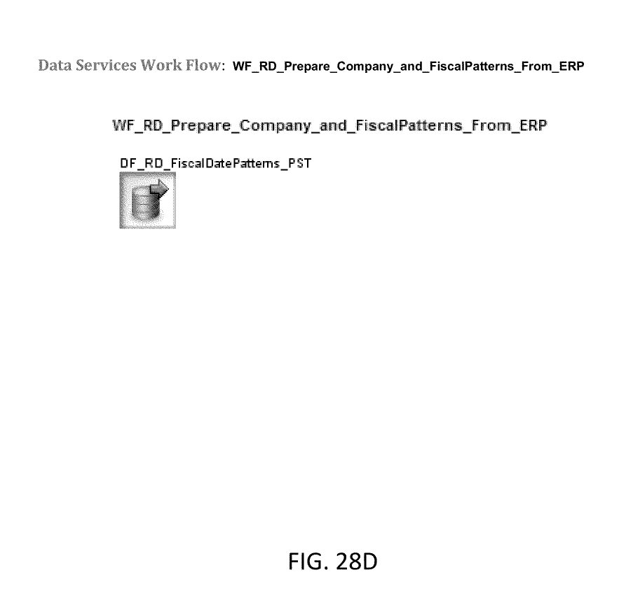

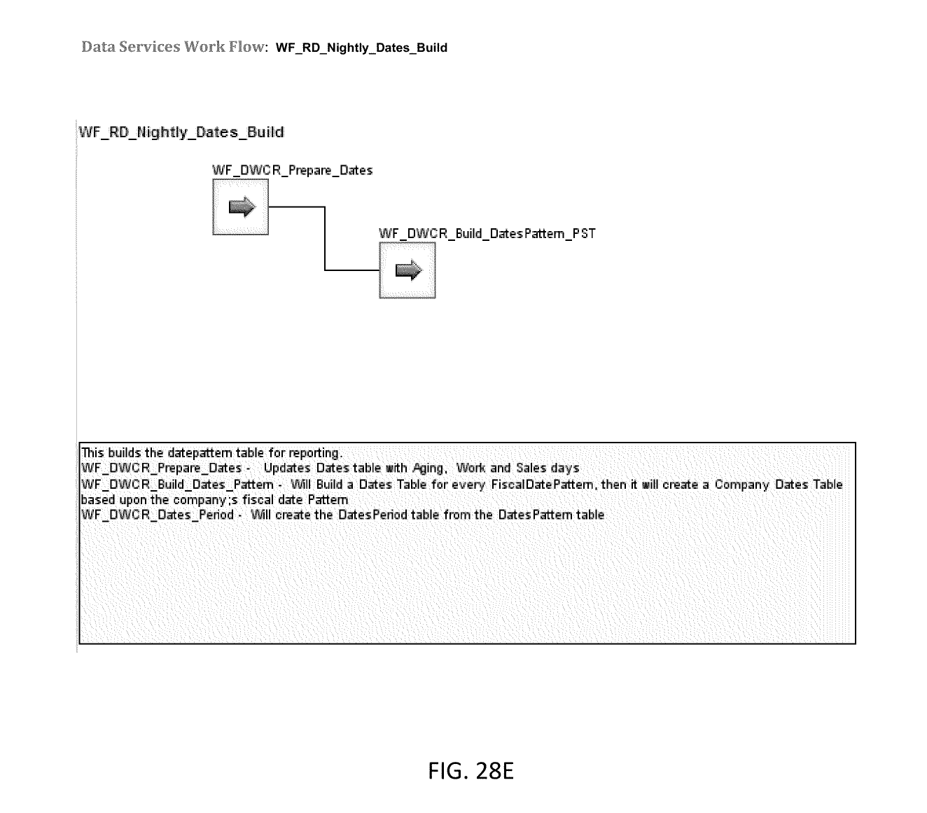

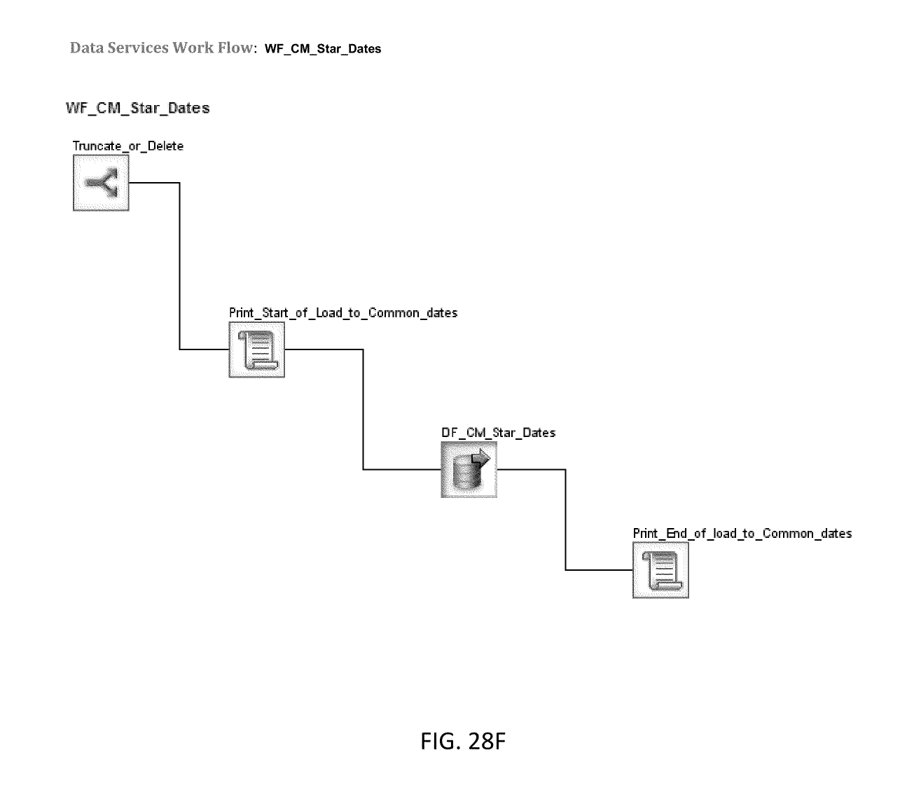

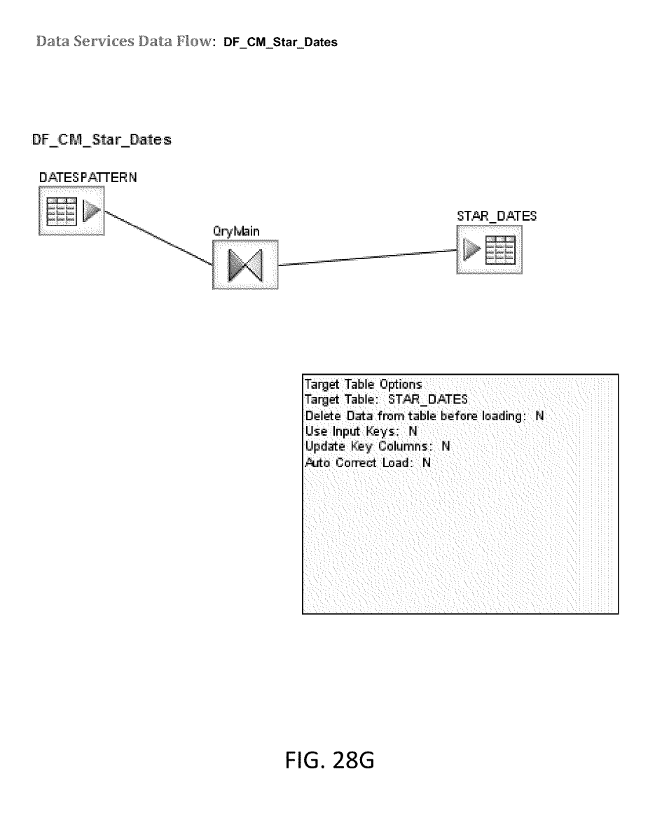

FIGS. 28A-G illustrate flow diagrams for an ETL tool that is used, for example, based on a PeopleSoft data source. FIG. 28A shows a workflow for the rebuild of a dates pattern for this source. FIG. 28B shows the variables used in the workflow of FIG. 28A. FIG. 28C and. FIG. 28D show workflows for assembly of date patterns associated with this source. FIG. 28E shows a workflow that builds the dates pattern table for reporting, by updating the dates table with aging, rolling, work, and sales day. FIG. 28F and FIG. 28G show workflows and dataflows for assembly of a STAR_DATES table for this source.

The methods and system are described in connection with the present inventions also integrate with other newly developed data sources, such as High Performance Analytic Appliance (HANA) provided by SAP®. SAP® HANA converges database and application platform capabilities in-memory to transform transactions, analytics, text analysis, predictive and spatial processing. The methods and systems of the present application facilitate the framework provided by SAP® HANA in various aspects. For example, by using modern in-memory databases, such as HANA, the methodology of the present invention provides HANA with the most granular or atomic level information that is 100% transactional information. Using the power of this in-memory database and using the views built in the HANA framework, a user can be presented with various levels of information, such as highly summarized, moderately summarized, and non-summarized information. The user can also be presented with data at any point, and the user can drill up or down as much as needed. This is made possible because the present methodology provides the most granular level of detail into HANA. Without the methodology described here, providing data in a continuously fed manner requires HANA administrators to refresh the entire contents of the data source into HANA, thus, creating a massive performance impact on the production system, the network, and the database. This also forces the HANA system to be inoperative (inactive or slow) during multiple periods of the day. The methodology disclosed here provides continuously fed data related to Adds, Changes, and Deletes of records, and thus, provides the minimum definable performance impact to the HANA system. Thus, HANA can function at full capacity at all times, 24 hours a day, 7 days a week, at the granular level or any summary level. The summary level can be pre-determined by a user during implementation efforts or can be set at the time of an adhoc reporting effort.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other aspects, functions and advantages are also within the scope of the invention.

Exemplary flowcharts, systems and methods of preferred embodiments of the invention are provided herein for illustrative purposes and are non-limiting examples thereof. One of ordinary skill in the art will recognize that exemplary systems and methods and equivalents thereof may include more or fewer steps than those illustrated in the exemplary flowcharts, and that the steps in the exemplary flowcharts may be performed in a different order than the order shown in the illustrative flowcharts.

What is claimed is:

1. A data warehousing system for storing data from a plurality of data sources comprising:
a first data source;
a second data source;
a data transfer system having a first transfer process that transfers data from the first data source and a second transfer process that transfers data from the second data source; and
a data storage device connected to the data transfer system, the storage device receiving data from the first data source with the first transfer process and receiving data from the second data source with the second transfer process.

2. The system of claim 1 wherein the data transfer system comprises an extract, transform and load (ETL) system.

3. The system of claim 2 wherein the ETL system further comprises a first ETL process to transfer data from the first data source to the data storage device and a second ETL process to transfer data from the second data source to the data storage device.

4. The system of claim 2 wherein the ETL system further comprises a first ETL server that receives data from the first data source.

5. The system of claim 2 wherein the ETL system further comprises a second ETL server that receives data from the second data source.

6. The system of claim 2, wherein the ETL system comprises a first ETL process that loads data from the first data source into a first repository and a second ETL process to transfer data from the first repository to the data storage device.

7. The system of claim 6, wherein the ETL system comprises a third ETL process that loads data from the second data source to a second repository and a fourth ETL process to transfer data from the second repository to the data storage device.

8. The system of claim 2, wherein the ETL system further comprises a process to generate a first source number corresponding to the first data source and to generate a second source number corresponding to the second data source.

9. The system of claim 2, wherein the ETL system further comprises an ETL process to extract data from a dates table of the first data source, transform the data, load the data into the data storage device, and generate and load fiscal period information, corporate period information, and current calendar information.

10. The system of claim 9, wherein the ETL process further to generate rolling periods based on the data in the dates table, and load the rolling periods into the data storage device.

11. The system of claim 2, wherein the ETL system uses a first fact table and a second fact table to generate a linked composite key.

12. The system of claim 11, wherein the ETL system generates a plurality of linked composite keys to form a linkage table.

13. The system of claim 2, wherein the ETL system loads key field of an interim table that is connectable to a fact table and a dimension table.

14. The system of claim 1 further comprising a first server that stores data for the first data source.

15. The system of claim 1 further comprising a second server that stores data for the second data source.

16. The system of claim 1 further comprising a central repository that receives data from the data transfer system.

17. The system of claim 1 wherein the data storage device comprises a data warehouse.

18. The system of claim 1 wherein the data storage device comprises a data mart.

19. The system of claim 1 wherein the transfer system further comprises a computing device including at least one data processor to execute stored instructions to perform at least the first transfer process.

20. The system of claim 19 wherein the computing device further comprises a user interface.

21. The system of claim 1 wherein the first data source is different from the second data source.

22. The system of claim 1 wherein the first data source comprises a first plurality of data fields.

23. The system of claim 1, wherein the second data source comprises a second plurality of data fields.

24. The system of claim 1, wherein the first transfer process comprises a first workflow sequence.

25. The system of claim 1, wherein the second transfer process comprises a second workflow sequence.

26. The system of claim 1, wherein the first data source has a first key format that is different from a second key format of the second data source.

27. The system of claim 1, wherein the first data source comprises data generated by a first enterprise resource planning system and the second data source comprises data generated by a second enterprise resource planning system.

28. The system of claim 1, wherein the transfer system generates a surrogate key.

29. The system of claim 28, wherein the transfer system generates the surrogate key by extracting a first value from a row of a table of the first data source, extracting a second value from the table, and generating the surrogate key for the row based on the first value and the second value.

30. The system of claim 29, wherein the transfer system generates surrogate keys for data in all rows of the table.

31. The system of claim 29, wherein the surrogate key is a concatenation of the first value and the second value.

32. The system of claim 28, wherein the transfer system generates a surrogate key without performing a lookup operation from a second table.

33. The system of claim 28, wherein the transfer system loads the surrogate key to the data storage device using an ETL process.

34. The system of claim 1, wherein the transfer system generates auditing information including date and time indicating at least one of when a record is added, when a record is last changed, when is a record last deleted, and when is a record purged, and loads the auditing information into the data storage device.

35. The system of claim 1, further comprising an ETL system that generates a derived surrogate key.

36. The system of claim 1, further comprising an ETL system that generates a plurality of surrogate keys loaded into a table having a plurality of rows and a plurality of columns.

37. The system of claim 1, wherein the data storage device stores an interim table having a plurality of key fields.

38. The system of claim 37, wherein the interim table comprises data representing a hierarchy schema for data in the first data source.

39. The system of claim 37, wherein data is loaded into the interim table based on a first enterprise, resource, planning (ERP) variable that defines loading parameters for the first data source.

40. The system of claim 1, further comprising a business intelligence system to generate reports based on data from the data device storage and a user input.

41. The system of claim 40, wherein the business intelligence system generates the reports based on a hierarchy level indicated by the interim table.

42. The system of claim 1, wherein the system comprises a dynamic distributed computing system having a plurality of servers.

43. The system of claim 1, further comprising a non-transitory computer readable medium having stored thereon a plurality of executable instructions to operate the [symbol]
